(19) United States
(12) Patent Application Publication
(10) Pub. No.: US 2023/0107698 A1
(43) Pub. Date: Apr. 6, 2023

(54) TECHNIQUES FOR SIDELINK FEEDBACK CHANNEL RESOURCE DETERMINATION

(71) Applicant: QUALCOMM Incorporated, San Diego, CA (US)

(72) Inventors: Ahmed Elshafie, San Diego, CA (US); Seyedkianoush Hosseini, San Diego, CA (US); Wei Yang, San Diego, CA (US); Tugcan Aktas, La Jolla, CA (US)

(21) Appl. No.: 17/479,680

(22) Filed: Sep. 20, 2021

(51) Int. Cl. H04W 72/02; H04W 72/04; H04L 1/18; H04W 28/26

(52) U.S. Cl. CPC H04W 72/02; H04L 1/1896; H04W 28/26; H04W 72/0446

(57) ABSTRACT

Methods, systems, and devices for wireless communications are described. A user equipment (UE) may support communicating sidelink feedback for a transport block communicated over multiple transmission time intervals (TTIs). For example, a first UE may receive one or more repetitions of a transport block from a second UE over a sidelink channel, where the one or more repetitions of the transport block may together span multiple TTIs. Each of the first UE and the second UE may identify at least one of the TTIs and may determine one or more resources of a sidelink feedback channel based on an index of the at least one TTI. The first UE may transmit, to the second UE, feedback pertaining to the reception of the one or more repetitions of the transport block over the determined one or more resources.

### TECHNICAL FIELD

The following relates to wireless communications, including techniques for sidelink feedback channel resource determination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support sidelink communications between UEs. In some examples, a first UE may transmit feedback to a second UE over a sidelink feedback channel. In some cases, techniques for determining resources of the sidelink feedback channel may be unknown or unsupported for particular scheduling and communication scenarios.

### SUMMARY

The described techniques relate to improved methods, systems, devices, and apparatuses that support techniques for sidelink feedback channel resource determination. Generally, the described techniques provide for communicating sidelink feedback when one or more repetitions of a transport block are communicated over multiple transmission time intervals (TTIs) (e.g., multiple slots, multiple mini-slots, or a combination thereof). For example, a first user equipment (UE) may communicate sidelink messages with a second UE over a sidelink channel. The second UE may transmit, to the first UE, one or more repetitions of a transport block that together span multiple TTIs. The first UE may receive the one or more repetitions of the transport block and may generate feedback pertaining to reception of the one or more repetitions of the transport block (e.g., whether the one or more repetitions of the transport block are successfully received). The first UE may then transmit the feedback to the second UE over or using one or more resources of a sidelink feedback channel.

To determine the one or more resources of the sidelink feedback channel, each of the first UE and the second UE may identify at least one of the multiple TTIs in accordance with a rule and may determine the one or more resources based on an index of the at least one TTI. For example, the rule may indicate for the UEs to use an index of a temporally first TTI of the multiple TTIs. Alternatively, the rules may indicate for the UEs to use an index of a temporally last TTI of the multiple TTIs. Additional and alternative rules are further described herein. Based on the identifying, the first UE and the second UE may use the index of the at least on TTI to determine the one or more resources of the sidelink feedback channel and may communicate the feedback over the one or more resources.

A method for wireless communication at a first UE is described. The method may include receiving, from a second UE over a sidelink channel, one or more repetitions of a transport block that together span a set of multiple TTIs, identifying, in accordance with a rule, at least one of the set of multiple TTIs to be used in determining one or more resources of a sidelink feedback channel for providing feedback pertaining to reception of the one or more repetitions of the transport block, determining the one or more resources of the sidelink feedback channel based on an index of the at least one of the set of multiple TTIs, and transmitting the feedback to the second UE over the one or more resources of the sidelink feedback channel.

An apparatus for wireless communication at a first UE is described. The apparatus may include at least one processor, and memory coupled (e.g., operatively, communicatively, functionally, electronically, or electrically) with the at least one processor, the memory storing instructions executable by the at least one processor to cause the apparatus to receive, from a second UE over a sidelink channel, one or more repetitions of a transport block that together span a set of multiple TTIs, identify, in accordance with a rule, at least one of the set of multiple TTIs to be used in determining one or more resources of a sidelink feedback channel for providing feedback pertaining to reception of the one or more repetitions of the transport block, determine the one or more resources of the sidelink feedback channel based on an index of the at least one of the set of multiple TTIs, and transmit the feedback to the second UE over the one or more resources of the sidelink feedback channel.

Another apparatus for wireless communication at a first UE is described. The apparatus may include means for receiving, from a second UE over a sidelink channel, one or more repetitions of a transport block that together span a set of multiple TTIs, means for identifying, in accordance with a rule, at least one of the set of multiple TTIs to be used in determining one or more resources of a sidelink feedback channel for providing feedback pertaining to reception of the one or more repetitions of the transport block, means for determining the one or more resources of the sidelink feedback channel based on an index of the at least one of the set of multiple TTIs, and means for transmitting the feedback to the second UE over the one or more resources of the sidelink feedback channel.

A non-transitory computer-readable medium storing code for wireless communication at a first UE is described. The code may include instructions executable by at least one processor to receive, from a second UE over a sidelink channel, one or more repetitions of a transport block that together span a set of multiple TTIs, identify, in accordance with a rule, at least one of the set of multiple TTIs to be used in determining one or more resources of a sidelink feedback channel for providing feedback pertaining to reception of the one or more repetitions of the transport block, determine the one or more resources of the sidelink feedback channel based on an index of the at least one of the set of multiple TTIs, and transmit the feedback to the second UE over the one or more resources of the sidelink feedback channel.

In some examples of the method, apparatuses, and non-transitory computer-readable medium described herein, receiving the one or more repetitions of the transport block may include operations, features, means, or instructions for receiving a single repetition of the transport block that spans the set of multiple TTIs, where identifying the at least one of the set of multiple TTIs may be based on receiving the single repetition of the transport block.

In some examples of the method, apparatuses, and non-transitory computer-readable medium described herein, identifying the at least one of the set of multiple TTIs may include operations, features, means, or instructions for identifying, in accordance with the rule, that all of the set of multiple TTIs may be to be used in determining the one or more resources of the sidelink feedback channel, where the feedback includes a quantity of feedback bits corresponding to a quantity of TTIs included in the set of multiple TTIs, each feedback bit representing the feedback for the single repetition of the transport block.

In some examples of the method, apparatuses, and non-transitory computer-readable medium described herein, receiving the one or more repetitions of the transport block may include operations, features, means, or instructions for receiving the one or more repetitions of the transport block during multiple feedback windows of time, each feedback window associated with a respective sidelink feedback channel occasion, where the sidelink feedback channel on which the feedback may be transmitted may be associated with a temporally last sidelink feedback channel occasion of the respective sidelink feedback channel occasions.

Some examples of the method, apparatuses, and non-transitory computer-readable medium described herein may further include operations, features, means, or instructions for generating the feedback after an entirety of the single repetition of the transport block may be received.

In some examples of the method, apparatuses, and non-transitory computer-readable medium described herein, receiving the one or more repetitions of the transport block may include operations, features, means, or instructions for receiving a set of multiple repetitions of the transport block that together span the set of multiple TTIs, each repetition of the set of multiple repetitions received over a different TTI of the set of multiple TTIs, where identifying the at least one of the set of multiple TTIs may be based on receiving the set of multiple repetitions of the transport block.

Some examples of the method, apparatuses, and non-transitory computer-readable medium described herein may further include operations, features, means, or instructions for generating acknowledgement information indicating whether the first UE successfully received the transport block based on decoding the set of multiple repetitions of the transport block, where the feedback includes the acknowledgement information.

In some examples of the method, apparatuses, and non-transitory computer-readable medium described herein, determining the one or more resources of the sidelink feedback channel may include operations, features, means, or instructions for determining, for each TTI of the set of multiple TTIs, a resource of the sidelink feedback channel based on an index of the TTI and based on a starting subchannel index of the transport block within the TTI or a quantity of subchannels associated with a sidelink shared channel included in the TTI. In some examples of the method, apparatuses, and non-transitory computer-readable medium described herein, transmitting the feedback to the second UE may include operations, features, means, or instructions for transmitting the acknowledgement information over each resource of the sidelink feedback channel determined for each TTI.

Some examples of the method, apparatuses, and non-transitory computer-readable medium described herein may further include operations, features, means, or instructions for generating, for each repetition of the set of multiple repetitions of the transport block, acknowledgement information indicating whether the first UE successfully received the repetition, where the feedback includes respective acknowledgement information for each repetition, and where a respective resource of the sidelink feedback channel used to transmit the respective acknowledgement information may be determined based on an index of a respective TTI and based on a starting subchannel index of the transport block within the respective TTI or a quantity of subchannels associated with a sidelink shared channel included in the respective TTI.

Some examples of the method, apparatuses, and non-transitory computer-readable medium described herein may further include operations, features, means, or instructions for determining that a first subset of repetitions of the set of multiple repetitions may be received before a minimum time gap before a first sidelink feedback channel occasion and that a second subset of repetitions of the set of multiple repetitions may be received after the minimum time gap, generating first acknowledgement information indicating whether the first UE successfully received the first subset of repetitions based on decoding the first subset of repetitions, where the feedback includes the first acknowledgement information and the sidelink feedback channel corresponding to the first sidelink feedback channel occasion, generating second acknowledgement information indicating whether the first UE successfully received the transport block based on decoding the first subset of repetitions and the second subset of repetitions, and transmitting second feedback to the second UE including the second acknowledgement information over one or more resources of a second sidelink feedback channel corresponding to a second sidelink feedback channel occasion subsequent to the first sidelink feedback channel occasion.

In some examples of the method, apparatuses, and non-transitory computer-readable medium described herein, identifying the at least one of the set of multiple TTIs may include operations, features, means, or instructions for identifying, in accordance with the rule, a temporally last TTI of the set of multiple TTIs, where determining the one or more resources of the sidelink feedback channel may be based on an index of the temporally last TTI and based on a starting subchannel index of the transport block within the temporally last TTI or a quantity of subchannels associated with a sidelink shared channel included in the temporally last TTI.

In some examples of the method, apparatuses, and non-transitory computer-readable medium described herein, identifying the at least one of the set of multiple TTIs may include operations, features, means, or instructions for identifying, in accordance with the rule, a temporally first TTI of the set of multiple TTIs, where determining the one or more resources of the sidelink feedback channel may be based on an index of the temporally first TTI and based on a starting subchannel index of the transport block within the temporally first TTI or a quantity of subchannels associated with a sidelink shared channel included in the temporally first TTI.

In some examples of the method, apparatuses, and non-transitory computer-readable medium described herein, the set of multiple TTIs includes a set of multiple mini-slots included in a slot, the index of the at least one of the set of multiple TTIs corresponding to an index of the slot.

In some examples of the method, apparatuses, and non-transitory computer-readable medium described herein, receiving the one or more repetitions of the transport block may include operations, features, means, or instructions for receiving the one or more repetitions of the transport block in accordance with a type of reservation associated with the set of multiple TTIs, where identifying the at least one of the set of multiple TTIs may be based on the type of reservation.

Some examples of the method, apparatuses, and non-transitory computer-readable medium described herein may further include operations, features, means, or instructions for determining the one or more resources of the sidelink feedback channel based on a respective starting subchannel index of the transport block within the at least one of the set of multiple TTIs or a respective quantity of subchannels associated with a sidelink shared channel included in the at least one of the set of multiple TTIs.

In some examples of the method, apparatuses, and non-transitory computer-readable medium described herein, the feedback includes a set of multiple feedback bits, each feedback bit transmitted using a different cyclic shift within non-overlapping resource blocks.

In some examples of the method, apparatuses, and non-transitory computer-readable medium described herein, the feedback includes a set of multiple feedback bits, each feedback bit transmitted using a same cyclic shift sequence per resource block.

In some examples of the method, apparatuses, and non-transitory computer-readable medium described herein, the set of multiple TTIs includes a set of multiple slots or a set of multiple mini-slots.

A method for wireless communication at a first UE is described. The method may include transmitting, to a second UE over a sidelink channel, one or more repetitions of a transport block that together span a set of multiple TTIs, identifying, in accordance with a rule, at least one of the set of multiple TTIs to be used in determining one or more resources of a sidelink feedback channel for receiving feedback pertaining to transmission of the one or more repetitions of the transport block, determining the one or more resources of the sidelink feedback channel based on an index of the at least one of the set of multiple TTIs, and receiving the feedback from the second UE over the one or more resources of the sidelink feedback channel.

An apparatus for wireless communication at a first UE is described. The apparatus may include at least one processor, and memory coupled (e.g., operatively, communicatively, functionally, electronically, or electrically) with the at least one processor, the memory storing instructions executable by the at least one processor to cause the apparatus to transmit, to a second UE over a sidelink channel, one or more repetitions of a transport block that together span a set of multiple TTIs, identify, in accordance with a rule, at least one of the set of multiple TTIs to be used in determining one or more resources of a sidelink feedback channel for receiving feedback pertaining to transmission of the one or more repetitions of the transport block, determine the one or more resources of the sidelink feedback channel based on an index of the at least one of the set of multiple TTIs, and receive the feedback from the second UE over the one or more resources of the sidelink feedback channel.

Another apparatus for wireless communication at a first UE is described. The apparatus may include means for transmitting, to a second UE over a sidelink channel, one or more repetitions of a transport block that together span a set of multiple TTIs, means for identifying, in accordance with a rule, at least one of the set of multiple TTIs to be used in determining one or more resources of a sidelink feedback channel for receiving feedback pertaining to transmission of the one or more repetitions of the transport block, means for determining the one or more resources of the sidelink feedback channel based on an index of the at least one of the set of multiple TTIs, and means for receiving the feedback from the second UE over the one or more resources of the sidelink feedback channel.

A non-transitory computer-readable medium storing code for wireless communication at a first UE is described. The code may include instructions executable by at least one processor to transmit, to a second UE over a sidelink channel, one or more repetitions of a transport block that together span a set of multiple TTIs, identify, in accordance with a rule, at least one of the set of multiple TTIs to be used in determining one or more resources of a sidelink feedback channel for receiving feedback pertaining to transmission of the one or more repetitions of the transport block, determine the one or more resources of the sidelink feedback channel based on an index of the at least one of the set of multiple TTIs, and receive the feedback from the second UE over the one or more resources of the sidelink feedback channel.

In some examples of the method, apparatuses, and non-transitory computer-readable medium described herein, transmitting the one or more repetitions of the transport block may include operations, features, means, or instructions for transmitting a single repetition of the transport block that spans the set of multiple TTIs, where identifying the at least one of the set of multiple TTIs may be based on transmitting the single repetition of the transport block.

In some examples of the method, apparatuses, and non-transitory computer-readable medium described herein, transmitting the one or more repetitions of the transport block may include operations, features, means, or instructions for transmitting a set of multiple repetitions of the transport block that together span the set of multiple TTIs, each repetition of the set of multiple repetitions transmitted over a different TTI of the set of multiple TTIs, where identifying the at least one of the set of multiple TTIs may be based on transmitting the set of multiple repetitions of the transport block.

In some examples of the method, apparatuses, and non-transitory computer-readable medium described herein, transmitting the one or more repetitions of the transport block may include operations, features, means, or instructions for transmitting the one or more repetitions of the transport block in accordance with a type of reservation associated with the set of multiple TTIs, where identifying the at least one of the set of multiple TTIs may be based on the type of reservation.

Some examples of the method, apparatuses, and non-transitory computer-readable medium described herein may further include operations, features, means, or instructions for determining the one or more resources of the sidelink feedback channel based on a respective starting subchannel index of the transport block within the at least one of the set of multiple TTIs or a respective quantity of subchannels associated with a sidelink shared channel included in the at least one of the set of multiple TTIs.

### BRIEF DESCRIPTION OF THE DRAWINGS

FIGS. 1 and 2 illustrate examples of wireless communications systems that support techniques for sidelink feedback channel resource determination in accordance with aspects of the present disclosure.

FIGS. 3A, 3B, 4A, and 4B illustrate examples of resource diagrams that support techniques for sidelink feedback channel resource determination in accordance with aspects of the present disclosure.

FIG. 5 illustrates an example of a process flow that supports techniques for sidelink feedback channel resource determination in accordance with aspects of the present disclosure.

FIGS. 6 and 7 show block diagrams of devices that support techniques for sidelink feedback channel resource determination in accordance with aspects of the present disclosure.

FIG. 8 shows a block diagram of a communications manager that supports techniques for sidelink feedback channel resource determination in accordance with aspects of the present disclosure.

FIG. 9 shows a diagram of a system including a device that supports techniques for sidelink feedback channel resource determination in accordance with aspects of the present disclosure.

FIGS. 10 through 16 show flowcharts illustrating methods that support techniques for sidelink feedback channel resource determination in accordance with aspects of the present disclosure.

### DETAILED DESCRIPTION

Some wireless communications systems may support sidelinks for communications between communication devices. Sidelinks may refer to any communication link between similar communication devices such as user equipment (UE). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some examples, UEs may communicate information using transport blocks. A transport block may refer to a payload that is communicated between a medium access control (MAC) layer and a physical layer of a layered protocol stack. In some examples, a transport block may undergo physical layer processing at a transmitter of a UE and may be mapped onto a physical channel (e.g., an instance of a physical sidelink shared channel (PSSCH)) for transmission over an air interface. The transport block may be segmented into code blocks and a cyclic redundancy check (CRC) may be added (e.g., to each code block) to support receiver-side error detection.

UEs may communicate sidelink feedback (e.g., hybrid automatic repeat request (HARQ) feedback) over a sidelink feedback channel, such as a physical sidelink feedback channel (PSFCH), for example, to indicate whether a sidelink message is successfully communicated (e.g., over a PSSCH, over a physical sidelink control channel (PSCCH)). In some examples, a UE may determine resources of the sidelink feedback channel for communicating the sidelink feedback based on one or more parameters, such as a starting subchannel of the PSSCH, a quantity of subchannels included in the PSSCH, a slot index containing the PSSCH, a source identifier (e.g., a identifier associated with a UE that transmits the sidelink message), a destination identifier (e.g., an identifier associated with the UE), or a combination thereof. In some cases, however, UEs may communicate one or more repetitions of a transport block over multiple transmission time intervals (TTIs) (e.g., slots, mini-slots, or a combination thereof), and rules and techniques for determining sidelink feedback resources and/or determining a quantity of feedback bits to include in sidelink feedback for the one or more repetitions of the transport block may be undefined or unknown. Thus, sidelink feedback for transport blocks that span multiple TTIs may be unsupported in such scheduling scenarios, thereby reducing resource utilization, channel scheduling efficiency, and data rates.

Techniques, systems, and devices are described herein for supporting sidelink feedback and resource determination when one or more repetitions of a transport block are scheduled over multiple TTIs. For example, a first UE may receive, from a second UE, one or more repetitions of a transport block that together span multiple TTIs. For instance, the second UE may transmit a single repetition of the transport block over the multiple TTIs. Alternatively, the second UE may transmit multiple repetitions of the transport block over the multiple TTIs with each repetition transmitted in a different TTI of the multiple TTIs. The first UE may receive the one or more repetitions of the transport block and may generate feedback pertaining to reception of the one or more repetitions of the transport block (e.g., whether the transport block is successfully received, whether each repetition of the transport block is successfully received). The first UE may then transmit the feedback to the second UE over or using one or more resources of a sidelink feedback channel.

To determine the one or more resources of the sidelink feedback channel, each of the first UE and the second UE may identify at least one of the multiple TTIs in accordance with a rule and may determine the one or more resources based on an index of the at least one TTI. For example, the rule may indicate for the UEs to use an index of a temporally first TTI of the multiple TTIs. Alternatively, the rules may indicate for the UEs to use an index of a temporally last TTI of the multiple TTIs. In some examples, the rule may be based on whether the second UE transmits a single repetition of the transport block or multiple repetitions of the transport block. Additional and alternative rules are further described herein. Based on the identifying, the first UE and the second UE may use the index of the at least on TTI to determine the one or more resources of the sidelink feedback channel and may communicate the feedback over the one or more resources.

Aspects of the subject matter described in this disclosure may be implemented to realize one or more of the following potential improvements, among others. The techniques employed by the UE may provide benefits and enhancements to the operation of the UE. For example, operations performed by the UE may provide improvements to sidelink feedback communications. In some examples, supporting the communication of sidelink feedback when one or more repetitions of a transport block are scheduled over multiple TTIs may increase data rates, spectral efficiency, and resource utilization of sidelink communications. In some other examples, supporting the communication of sidelink feedback when one or more repetitions of a transport block are scheduled over multiple TTIs may provide improvements to sidelink scheduling efficiency, reliability, coordination between devices, and latency, among other benefits.

Aspects of the disclosure are initially described in the context of wireless communications systems. Aspects of the disclosure are additionally described in the context of resource diagrams and a process flow. Aspects of the disclosure are further illustrated by and described with reference to apparatus diagrams, system diagrams, and flowcharts that relate to techniques for sidelink feedback channel resource determination.

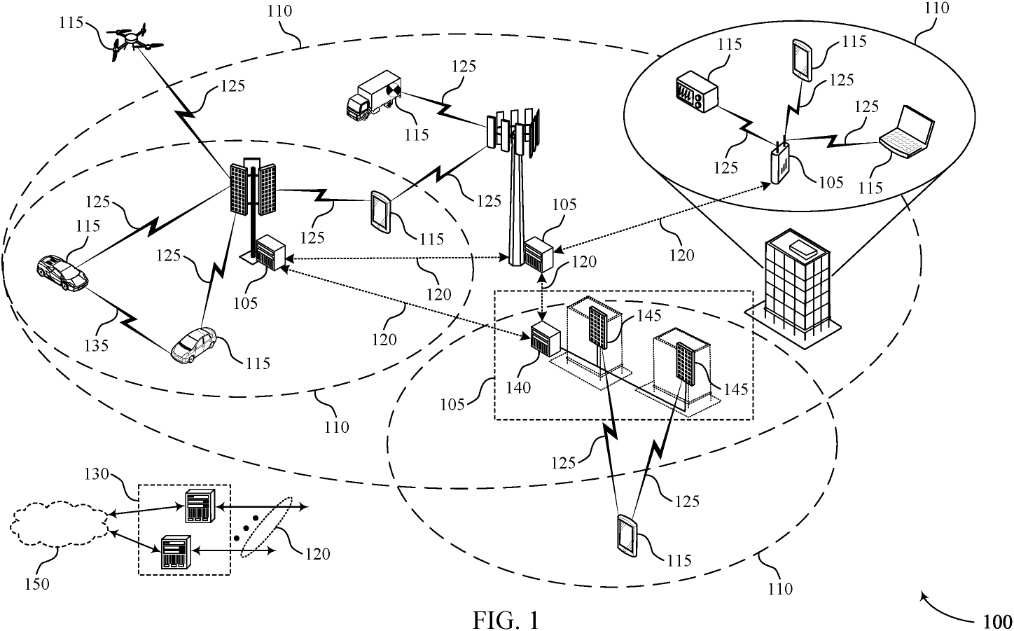

FIG. 1 illustrates an example of a wireless communications system 100 that supports techniques for sidelink feedback channel resource determination in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ = ⅟(Δfₘₐₓ ▪N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI. In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may be an example of a sidelink network. Here, the sidelink network may support one or more resource allocation modes to coordinate sidelink communications between UEs 115 (e.g., over D2D communication links 135, over PC5 links). For example, the sidelink network may be configurable to operate according a Mode 1 resource allocation mode and/or a Mode 2 resource allocation mode. While operating in Mode 1, the sidelink network (e.g., sidelink communications over the sidelink network) may be managed (e.g., coordinated) by a base station 105. For example, during Mode 1 operation, the base station 105 may manage sidelink resource allocation over the sidelink network.

While operating in Mode 2, the sidelink network may not be managed or coordinated by the base station 105. Without coordination or management of sidelink resources of the sidelink network during the Mode 2 operation, UEs 115 may follow contention-based access procedures in which the various UEs 115 may reserve sidelink resources of the sidelink network. For example, during Mode 2 operation, a UE 115 may monitor the sidelink network to determine if other UEs 115 are attempting to transmit over the sidelink network. For instance, the UE 115 may decode one or more reservation messages (e.g., sidelink control channel transmissions such as sidelink control information (SCI) messages, SCI-1 messages, SCI-2 messages, request-to-send-messages, or some other sidelink control channel transmissions) and may determine which sidelink resources are reserved for other sidelink communications and which sidelink resources are available for sidelink communications based on the reservation messages. In some examples, the UE 115 may determine whether a sidelink resource is reserved based on measuring a reference signal received power (RSRP) of an associated reservation message. In some cases, the UE 115 may determine which sidelink resources are available for sidelink communications based on reservation messages decoded during a sensing window, where the sensing window corresponds to some duration of time prior to the arrival of a packet of information. In some examples, the packet arrival may trigger the UE 115 to determine which sidelink resources are available and to reserve sidelink resources.

In some examples, UEs 115 may be configured with one or more sidelink resource pools from which to select and reserve sidelink resources (e.g., during Mode 2 operation). In some cases, sidelink resource pools may include transmit sidelink resource pools (e.g., sets of sidelink resources over which the UE 115 may transmit sidelink messages) and receive sidelink resource pools (e.g., sets of sidelink resources over which the UE 115 may receive sidelink messages). The sidelink resource pools may be configured for Mode 1 communications or for Mode 2 communications. In some examples, a sidelink resource pool configuration for a sidelink resource pool may include a PSSCH configuration, a PSCCH configuration, a PSFCH configuration, a quantity of subchannels in the sidelink resource pool, a subchannel size (e.g., bandwidth), a starting resource block of the sidelink resource pool, a modulation and coding scheme (MCS) associated with the sidelink resource pool, a sensing configuration, a power control configuration, a constant bit rate (CBR), or a combination thereof.

In order to reduce latency and increase scheduling efficiency, UEs 115 may support mini-slot scheduling in which a slot is split into multiple mini-slots. Each mini-slot may include resource allocations for a PSCCH, a PSSCH, or a combination thereof, and may be self-schedulable and self-decodable. In some examples, a slot may be split into mini-slots according to a given pattern that indicates a length of each mini-slot (e.g., in a quantity of symbols) and a quantity of mini-slots into which the slot is split. In some cases, one or more gap (e.g., guard) symbols may be allocated at the end of a mini-slot if transmit/receive switching occurs for a next mini-slot. That is, if the UE 115 transmits or receives messages in a mini-slot and then receives or transmits messages, respectively, in a next mini-slot, one or more gap symbols may be allocated at the end of the mini-slot to support the transmit/receive switching. In some examples, a PSCCH transmission may be configured at a beginning of a split slot (e.g., in an earliest mini-slot) and PSSCH transmissions may be configured for remaining mini-slots of the split slot. The PSCCH transmission may include SCI that reserves a quantity of slots in the same split slot or one or more future slots. Additionally, in some examples, a UE 115 may transmit one or more automatic gain control (AGC) symbols (e.g., symbols that enable the dynamic power adjustment of a received signal to reduce quantization or clipping errors) in the PSCCH transmission and may refrain from transmitting AGC symbols in the PSSCH transmissions. Here, a receiver UE 115 may apply a same power adjustment indicated by the one or more AGC symbols to receive the PSSCH transmissions.

A UE 115 may select and reserve one or multiple mini-slots per slot (e.g., based on decoding one or more reservation messages). In some examples, a UE 115 may support mini-slot scheduling to communicate transport blocks. For example, a UE 115 may reserve multiple mini-slots (e.g., over one or more slots) according to a first reservation type (e.g., a type A reservation) in which the mini-slots are bundled and used to transmit a single repetition of a single transport block. Alternatively, a UE 115 may reserve multiple mini-slots (e.g., over one or more slots) according to a second reservation type (e.g., a type B reservation) in which the reserved mini-slots are each used to a transmit a single and different repetition of a same transport block. In some cases, multiple bundled or reserved mini-slots may be referred to as a super slot or a super mini-slot and may span one or more slots.

Various aspects of the described techniques support sidelink feedback and resource determination when one or more repetitions of a transport block are scheduled over multiple TTIs (e.g., in accordance with type A and type B reservations). For example, a first UE 115 may receive, from a second UE 115, one or more repetitions of a transport block that together span multiple TTIs. In response, the first UE 115 may generate feedback that indicates whether the transport block is successfully received, or whether one or more (e.g., each) repetitions of the transport block are successfully received. The first UE 115 and the second UE 115 may determine one or more resources of a PSFCH to communicate the feedback. For example, the first UE 115 and the second UE 115 may identify at least one of the multiple TTIs in accordance with a rule and may determine the one or more resources based on an index of the at least one TTI. Then, the first UE 115 may transmit the feedback to the second UE 115 over or using the one or more resources of the PSFCH.

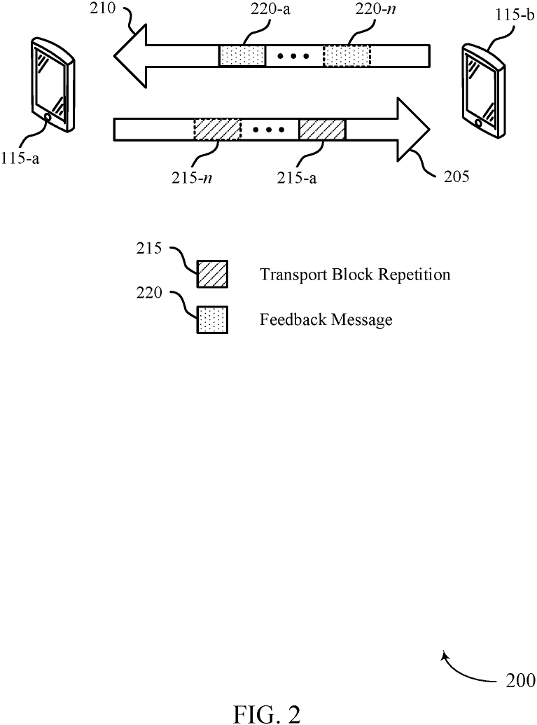

FIG. 2 illustrates an example of a wireless communications system 200 that supports techniques for sidelink feedback channel resource determination in accordance with aspects of the present disclosure. The wireless communications system 200 may implement aspects of the wireless communications system 100 or may be implemented by aspects of the wireless communications system 100. For example, the wireless communications system 200 may include a UE 115-a and a UE 115-b, which may be examples of a UE 115 described with reference to FIG. 1. In some examples, the wireless communications system 200 may support multiple radio access technologies including fourth generation (4G) systems such as LTE systems, LTE-A systems, or LTE-A Pro systems, and fifth generation (5G) systems which may be referred to as NR systems. The wireless communications system 200 may support PSFCH resource and feedback determination to support improvements to data rates, capacity, spectral efficiency, coordination between devices, resource utilization, reliability, sidelink scheduling efficiency, and latency, among other benefits.

The wireless communications system 200 may support sidelink communications between the UEs 115. For example, the UE 115-a may transmit and the UE 115-b may receive sidelink messages over a sidelink 205, and the UE 115-b may transmit and the UE 115-a may receive sidelink messages over a sidelink 210, each of which may be respective examples of a D2D communication link 135 (as described with reference to FIG. 1). In some examples, the wireless communications system 200 may be configured to operate according to a Mode 2 resource allocation mode.

The wireless communications system 200 may support sidelink feedback communications between the UE 115-a and the UE 115-b in response to communicating one or more repetitions of a transport block that together span multiple TTIs. For example, the UE 115-a may select and reserve sidelink resources (e.g., via SCI transmission in accordance with Mode 2 operations) that span multiple mini-slots, multiple slots, or a combination thereof. The UE 115-a may use the reserved sidelink resources to transmit one or more transport block repetitions 215 (e.g., one or more repetitions of a same transport block) to the UE 115-b (e.g., over a PSSCH). For example, the UE 115-a may reserve the sidelink resources in accordance with a type A reservation and may transmit a transport block repetition 215-a that spans multiple mini-slots, multiple slots, or a combination thereof, in accordance with the reservation of the sidelink resources. Alternatively, the UE 115-a may reserve the sidelink resources in accordance with a type B reservation and may transmit the transport block repetitions 215-a through a transport block repetition 215-n that together span the multiple mini-slots, multiple slots, or the combination thereof, in accordance with the reservation of the sidelink resources. In some examples, if mini-slot scheduling is implemented, the UE 115-a may transmit each transport block repetition 215 in a different mini-slot in accordance with the type B reservation. In some cases, this may result in UE 115-a transmitting transport block repetitions 215 over multiple slots if mini-slots spanning more than one slot are reserved. In some examples, if slots scheduling is implemented, the UE 115-a may transmit each transport block repetition 215 in a different slot in accordance with the type B reservation.

In response to receiving the transport block repetition(s) 215, the UE 115-b may generate feedback pertaining to reception of the transport block repetition(s) 215. For example, the UE 115-b may generate acknowledgement information (e.g., HARQ feedback such as an acknowledgement (ACK) or a negative ACK (NACK)) that indicates whether the UE 115-b successfully received the transport block (e.g., based on decoding the transport block repetition 215-n, based on decoding the transport block repetition 215-a through the transport block repetition 215-n, based on a combination of the transport block repetition 215-a through the transport block repetition 215-n), or whether the UE 115-b successfully received each transport block repetition 215.

The UE 115-b may determine one or more resources of a PSFCH (e.g., one or more PSFCH occasions) for transmitting one or more feedback messages 220 that carry the generated feedback. Additionally, the UE 115-a may determine the one or more resources of the PSFCH for receiving the one or more feedback messages 220. In some examples, the UE 115-b and the UE 115-a may determine the one or more resources based on a mapping between one or more PSSCHs over which the transport block repetitions 215 are received and the PSFCH. For example, the mapping may map PSFCH resources based on one or more parameters such as a starting subchannel of a PSSCH, a quantity of subchannels included in the PSSCH, a slot index containing the PSSCH, a mini-slot index containing the PSSCH, a source identifier (e.g., a identifier associated with the UE 115-a), a destination identifier (e.g., an identifier associated with the UE 115-b), or a combination thereof.

To support the mapping, the UE 115-b (e.g., and the UE 115-a) may be configured with a PSFCH periodicity parameter (e.g., a periodPSFCHresource parameter) that indicates a periodicity of the PSFCH (e.g., how often PSFCH occasions occur) in a quantity of TTIs (e.g., a quantity of slots, a quantity of mini-slots) within a sidelink resource pool. In some examples, the PSFCH periodicity parameter may be set to 0, 1, 2, 4, or some other value. If the PSFCH periodicity parameter is set to 0, PSFCH transmissions from the UEs 115 may be disabled within the sidelink resource pool. If the PSFCH periodicity parameter is set to 1, a PSFCH occasion may occur every other TTI; if the PSFCH periodicity parameter is set to 2, a PSFCH occasion may occur after every two TTIs, and so on. In some examples, the UE 115-b may be configured to transmit the generated feedback in a first (e.g., earliest) PSFCH occasion (e.g., a slot or mini-slot that includes PSFCH resources) that is at least a threshold quantity of TTIs (e.g., slots or mini-slots) after a last TTI of a PSSCH reception. In some cases, the threshold quantity of TTIs may be (e.g., correspond to) a minimum time gap before a PSFCH occasion (e.g., indicated by

$$\text{a} M i n T i m e G a p P S F C H$$

parameter) that the last TTI of the PSSCH reception may occur in order to transmit feedback associated with the PSSCH reception in the PSFCH occasion.

The UE 115-a and the UE 115-b may additionally be configured with a set of

$${M}_{P R B , s e t}^{P S F C H}$$

physical resource blocks (PRBs) of a sidelink resource pool for PSFCH transmissions (e.g., indicated via an

$$r b S e t P S F C H$$

parameter); a quantity of

$${N}_{s u b c h}$$

subchannels for the sidelink resource pool (e.g., indicated via a

$$n u m S u b c h a n n e l$$

parameter); a quantity of

$${N}_{P S S C H}^{P S F C H}$$

PSSCH TTIs associated with a PSFCH TTI that is determined by the PSFCH periodicity parameter. In some examples,

$${M}_{P R B , s e t}^{P S F C H} = a * {N}_{s u b c h} * {N}_{P S S C H}^{P S F C H} ,$$

where a is some positive integer. In some examples,

$${M}_{s u b c h , T T I}^{P S F C H} = \frac{{M}_{P R B , s e t}^{P S F C H}}{{N}_{s u b c h} * {N}_{P S S C H}^{P S F C H}} ,$$

where

$${M}_{s u b c h , T T I}^{P S F C H}$$

corresponds to a quantity of PRBs of the

$${M}_{P R B , s e t}^{P S F C H}$$

PRBs that are allocated for sidelink feedback transmission.

The UE 115-a and the UE 115-b may use a TTI index (e.g., a slot index, a mini-slot index), a starting subchannel index of a PSSCH, a quantity of subchannels included in the PSSCH, or a combination thereof to determine which PRBs of

$${M}_{P R B , s e t}^{P S F C H}$$

PRBs to use for feedback communication. For example, the UE 115-a and the UE 115-b may allocate the

$$\left[\left(i + j * {N}_{P S S C H}^{P S F C H}\right) * {M}_{s u b c h , T T I}^{P S F C H} , \left(i + 1 + j * {N}_{P S S C H}^{P S F C H}\right) *\right) \left({M}_{s u b c h , s l o t}^{P S F C H} - 1\right]$$

PRBs from the set of

$${M}_{P R B , s e t}^{P S F C H}$$

PRBs to the TTI having index i and the subchannel having index j if

$${M}_{s u b c h , T T I}^{P S F C H} = 2$$

, where

$$0 \leq i < {N}_{\text{PSSCH}}^{\text{PSFCH}} , 0 \leq j < {N}_{\text{subch}}$$

, and the allocation starts in an ascending order of i and continues in an ascending order of j.

In some examples, the UE 115-a and the UE 115-b may UE determines a number of PSFCH resources available for multiplexing feedback in a PSFCH transmission as

$${R}_{P R B , C S}^{P S F C H} = {N}_{t y p e}^{P S F C H} * {M}_{s u b c h , T T I}^{P S F C H} * {N}_{C S}^{P S F C H}$$

where

$${N}_{C S}^{P S F C H}$$

is a number of cyclic shift pairs for the resource pool and, based on an indication by higher layers,

$${N}_{t y p e}^{P S F C H} = 1$$

and the

$${M}_{s u b c h , T T I}^{P S F C H}$$

PRBs are associated with the starting subchannel of the PSSCH, or

$${N}_{t y p e}^{P S F C H} = {N}_{s u b c h}^{P S S C H}$$

and the

$${N}_{s u b c h}^{P S S C H} ⋅ {M}_{s u b c h , T T I}^{P S S C H}$$

PRBs are associated with one or more subchannels from the

$${N}_{s u b c h}^{P S S C H}$$

sub-channels of the PSSCH. In some cases, the PSFCH resources are first indexed according to an ascending order of the PRB index, from the

$${N}_{t y p e}^{P S F C H} ⋅ {M}_{s u b c h , T T I}^{P S F C H}$$

PRBs, and then according to an ascending order of the cyclic shift pair index from the

$${N}_{\text{CS}}^{\text{PSFCH}}$$

cyclic shift pairs.

In some examples, the UE 115-a and the UE 115-b may determine an index of a PSFCH resource for a PSFCH transmission in response to a PSSCH reception as

$$\left(\left({P}_{\text{ID}} + {M}_{\text{ID}} + T T {I}_{i n d e x}\right)\right) m o d {R}_{\text{PRB,} \text{CS}}^{\text{PSFCH}}$$

, where P_{ID} is a physical layer source ID provided by SCI that schedules (e.g., and reserves sidelink resources for) the PSSCH reception (e.g., a destination identifier of the UE 115-a), M_{ID} is an identity of the UE 115 that receives the PSSCH (e.g., a source identifier of the UE 115-b) or is zero, and TTI_{index} is an index of the TTI over which the PSSCH is received. In some cases, the TTI may correspond to a mini-slot, and the TTI_{lndex} may be an index of the mini-slot.

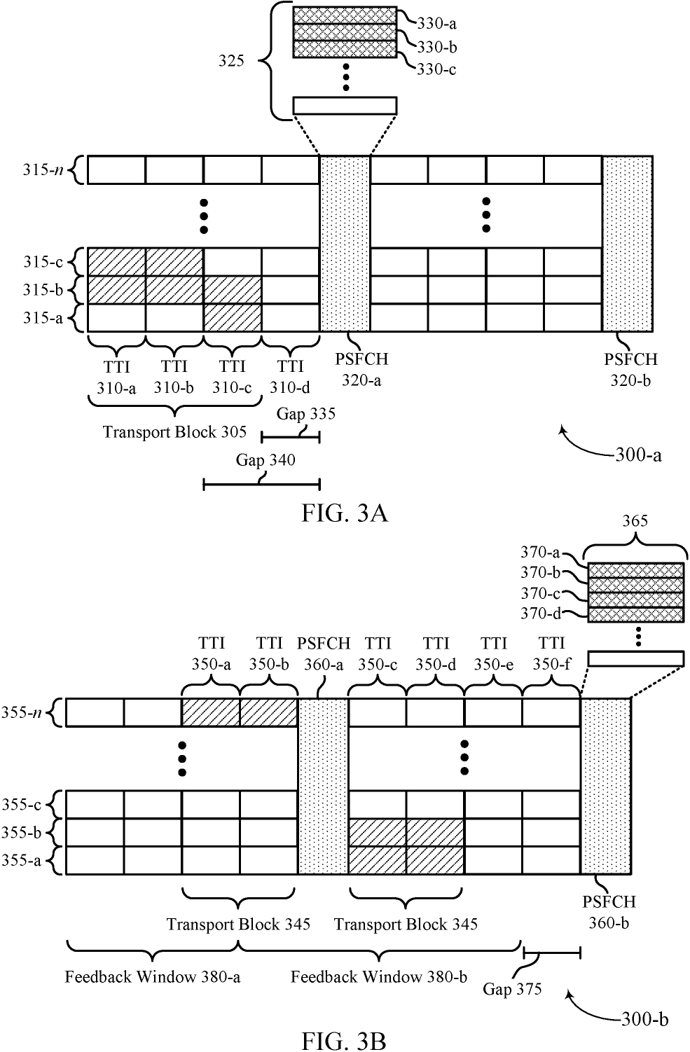

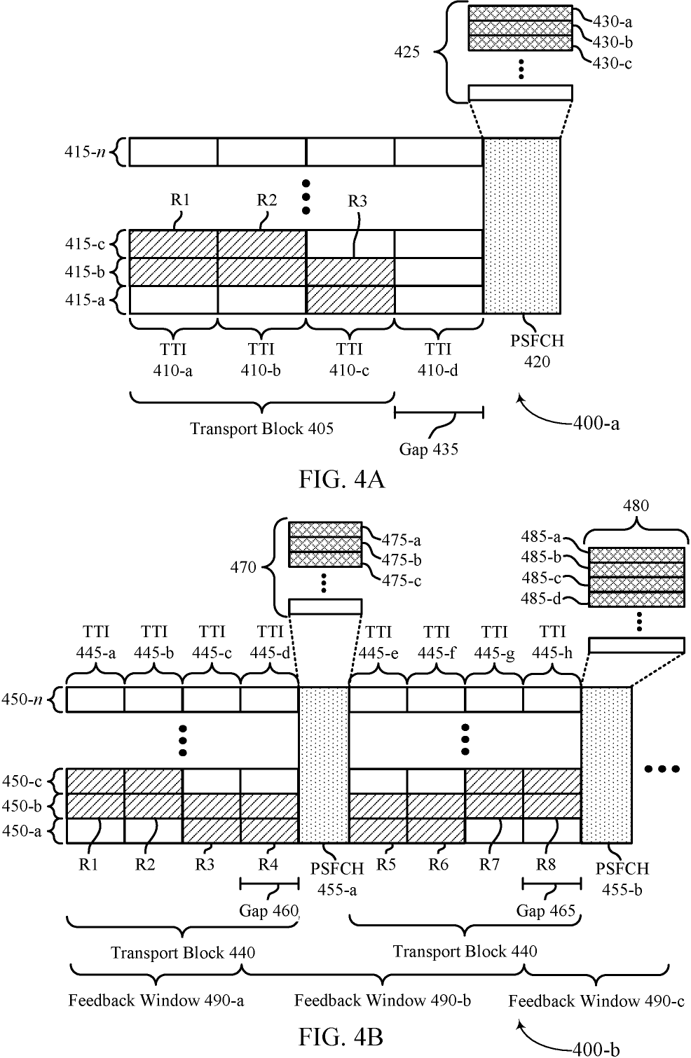

The UE 115-a and the UE 115-b may determine one or more PRBs of one or more PSFCH occasions to transmit the generated feedback based on mapping one or more of the PSSCHs over which the UE 115-a transmits the transport block repetition(s) 215 to the one or more PRBs of the one or more PSFCH occasions. The UE 115-b may transmit, to the UE 115-a, the one or more feedback messages 220 (e.g., a feedback message 220-a through a feedback message 220-n) that carry the generated the feedback over the determined PRBs. Additional details related to determining PSFCH resources and generating feedback are further described with reference to FIGS. 3A through 4B below. For example, FIGS. 3A through 4B describe rules and techniques for determining which TTI indexes and subchannel indexes to use in determining PSFCH resources and determining how many feedback bits to generate, among other details described in FIGS. 3A through 4B.

FIG. 3A illustrates an example of a resource diagram 300-a that supports techniques for sidelink feedback channel resource determination in accordance with aspects of the present disclosure. The resource diagram 300-a may be implemented by aspects of the wireless communications system 100 and 200 as described with reference to FIGS. 1 and 2, respectively. For example, the resource diagram 300-a may be implemented by one or more UEs 115 to support PSFCH feedback and resource determination which may provide improvements to data rates, capacity, spectral efficiency, coordination between devices, resource utilization, reliability, sidelink scheduling efficiency, and latency, among other benefits.

The resource diagram 300-a depicts a sidelink resource pool that includes a quantity of TTIs 310 that each span a quantity of subchannels 315 (e.g., subchannel 315-a through subchannel 315-n). In some examples, each TTI 310 may correspond to a slot. In some other examples, each TTI 310 may correspond to a mini-slot. Here, two or more mini-slots may span a single slot. For example, if slots are split into two mini-slots, a TTI 310-a and a TTI 310-b may each correspond to a mini-slot of a first slot and a TTI 310-c and a TTI 310-d may each correspond to a mini-slot of a second slot. Alternatively, if slots are split into four mini-slots, the TTI 310-a through the TTI 310-d may each correspond to a mini-slot of a single slot. It is noted that other slot and mini-slot combinations are possible. The resource diagram 300-a additionally depicts the sidelink resource pool as including PSFCHs 320 that occur in accordance with a PSFCH periodicity parameter. In the example of FIG. 3A, the PSFCH periodicity parameter may indicate for a PSFCH occasion to occur after every fourth TTI 310 (e.g., after every fourth slot, after every fourth mini-slot, after every other slot if the TTIs 310 span two slots, after every slot if the TTIs 310 span a single slot), although other PSFCH periodicity parameter values are possible. Accordingly, the resource diagram 300-a depicts a PSFCH 320-a occurring after the TTI 310-d and a PSFCH 320-b occurring after a fourth TTI 310 following the PSFCH 320-a. Each PSFCH 320 may include a set of PSFCH resources 325. In some examples, each PSFCH 320 may span a slot or a mini-slot in the time domain. For example, each PSFCH 320 may include PSFCH resources 330 (e.g., that correspond to PRBs) that each span a slot (e.g., if a TTI 310 corresponds to a slot or if a TTI 310 corresponds to a mini-slot) or a mini-slot (e.g., if a TTI 310 corresponds to a mini-slot).

The resource diagram 300-a depicts a transport block 305 that is communicated between a first UE 115 and a second UE (e.g., transmitted by the second UE 115 to the first UE 115) over the TTI 310-a, the TTI 310-b, and the TTI 310-c. In the example of FIG. 3A, the first UE 115 may receive a single repetition of the transport block 305 over the TTIs 310-a through 310-c. That is, the transport block 305 may include a single repetition that spans the TTIs 310-a through 310-c (e.g., in accordance with a type A reservation). The second UE 115 may transmit the transport block 305 over one or more subchannels 315. In some examples, the second UE 115 may transmit the transport block 305 over or using same or different subchannels 315 in each TTI 310 (e.g., in accordance with a frequency hopping scheme). In the example of FIG. 3A, the second UE 115 may transmit the transport block 305 over subchannel 315-b and subchannel 315-c in the TTI 310-a and the TTI 310-b and over subchannel 315-a and subchannel 315-b in the TTI 310-c.

In response to receiving the transport block 305, the first UE 115 may generate feedback pertaining to reception of the transport block 305. For example, the first UE 115 may generate acknowledgement information that indicates whether the first UE 115 successfully received the transport block 305. In some examples, the first UE 115 may generate a single HARQ feedback bit indicating an ACK or a NACK associated with the transport block 305 reception. In some other examples, the first UE 115 may generate multiple HARQ feedback bits that each indicate the ACK or the NACK. That is, the multiple HARQ feedback bits may have a same value.

The first UE 115 may determine which one or more PSFCH resources 330 of the set of PSFCH resource 325 to use to transmit the generated feedback in accordance with a rule. The second UE 115 may additionally determine the one or more PSFCH resources 330 in accordance with the rule in order to determine over which PSFCH resources 330 to receive the generated feedback. For example, the rule may indicate for the first UE 115 and the second UE 115 to identify a temporally last TTI 310 (e.g., a latest TTI 310 in the time domain) of the transport block 305 to use in determining the one or more PSFCH resources 330 (e.g., based on communicating the transport block 305 in accordance with a type A reservation). Accordingly, the first UE 115 and the second UE 115 may identify the TTI 310-c and may use an index of the TTI 310-c to determine the one or more PSFCH resources 330. In some examples, the first UE 115 and the second UE 115 may use an index of a starting subchannel 315 (e.g., a lowest frequency subchannel 315) of the TTI 310-c (e.g., an index of the subchannel 315-a) in conjunction with the index of the TTI 310-c to determine the one or more PSFCH resources 330. In some cases, the first UE 115 and the second UE 115 may use a quantity of subchannels 315 used to transmit the transport block in the TTI 310-c (e.g., a quantity of two subchannels 315 based on communicating the transport block 305 over subchannel 315-a and subchannel 315-b) in conjunction with the index of the TTI 310-c to determine the one or more PSFCH resources 330.

Alternatively, the rule may indicate for the first UE 115 and the second UE 115 to identify a temporally first TTI 310 (e.g., an earliest TTI 310 in the time domain) of the transport block 305 to use in determining the one or more PSFCH resources 330 (e.g., based on communicating the transport block 305 in accordance with a type A reservation). Accordingly, the first UE 115 and the second UE 115 may identify the TTI 310-a and may use an index of the TTI 310-a and an index of the starting subchannel 315 of the TTI 310-a (e.g., an index of the subchannel 315-b) or a quantity of subchannels 315 used to transmit the transport block in the TTI 310-a to determine the one or more PSFCH resources 330.

In some examples, the first UE 115 and the second UE 115 may determine the one or more PSFCH resource 330 based on a quantity of HARQ feedback bits generated. For example, if the first UE 115 is configured to generate a single HARQ feedback bit in response to receiving the transport block 305, the first UE 115 and the second UE 115 may determine, in accordance with the rule, a single PSFCH resource 330 (e.g., a PSFCH resource 330-a) of the set of PSFCH resources 325 to communicate the HARQ feedback bit. Alternatively, the first UE 115 may be configured to generate the HARQ feedback bit for each TTI 310 over which the transport block 305 is received (e.g., to increase a reliability of transmitting the generated feedback). For example, the first UE 115 may generate the HARQ feedback bit three times based on receiving the transport block 305 over three TTIs 310. Here, the first UE 115 and the second UE 115 may determine, in accordance with the rule, three PSFCH resources 330 (e.g., the PSFCH resource 330-a, a PSFCH resource 330-b, and a PSFCH resource 330-c) of the set of PSFCH resources 325 to communicate the HARQ feedback bits.

In some examples, the first UE 115 and the second UE 115 may use each of the TTIs 310 to determine a corresponding PSFCH resource 330 and communicate the HARQ feedback bits. For example, the first UE 115 and the second UE 115 may identify, in accordance with the rule, to use all of all of the TTIs 310 (e.g., TTI indexes and starting subchannel indexes or subchannel quantities) in determining the PSFCH resources 330.

Based on determining the one or more PSFCH resources 330, the first UE 115 and the second UE 115 may communicate the generated feedback (e.g., the single HARQ feedback bit, the multiple HARQ feedback bits) over or using the one or more PSFCH resources 330. For example, the first UE 115 may transmit the generated feedback to the second UE 115 over or using the one or more PSFCH resources 330. In some examples, if the first UE 115 generates multiple HARQ feedback bits, the first UE 115 may transmit each HARQ feedback bit using a different cyclic shift within non-overlapping PRBs. For example, if the first UE 115 determines a different PSFCH resource 330 to transmit each HARQ feedback bit, the first UE 115 may transmit each HARQ feedback bit using a different cyclic shift. In some examples, the first UE 115 may transmit each HARQ feedback bit using a same cyclic shift sequence corresponding to the transport block 305 in each determined PSFCH resource 330.

In some examples, the first UE 115 and the second UE 115 may determine in which PSFCH 320 to communicate the generated feedback based on a minimum time gap (e.g., indicated by a MinTimeGapPSFCH parameter). If the minimum time gap is satisfied, the first UE 115 may transmit the generated feedback in a next PSFCH 320. Alternatively, if the minimum time gap fails to be satisfied, the first UE 115 may refrain from transmitting the generated feedback until a next PSFCH 320 after the next PSFCH 320. For example, the first UE 115 and the second UE 115 may be configured with a gap 335 indicating a single TTI gap before the PSFCH 320-a before which an entirety of the transport block 305 may be received in order to transmit the generated feedback over the PSFCH 320-a. Accordingly, based on receiving the entirety of the transport block 305 before the gap 335, the first UE 115 may determine that the gap 335 is satisfied and may transmit the generated feedback over or using one or more PSFCH resources of the PSFCH 320-a. Alternatively, the first UE 115 and the second UE 115 may be configured with a gap 340 indicating a two TTI gap before the PSFCH 320-a before which an entirety of the transport block 305 may be received in order to transmit the generated feedback over the PSFCH 320-a. Accordingly, based on receiving the entirety of the transport block 305 after the gap 340, the first UE 115 may determine that the gap 335 fails to be satisfied and may transmit the generated feedback over or using one or more PSFCH resources of the PSFCH 320-b, corresponding to a next PSFCH 320 after the PSFCH 320-a.

FIG. 3B illustrates an example of a resource diagram 300-b that supports techniques for sidelink feedback channel resource determination in accordance with aspects of the present disclosure. The resource diagram 300-b may be implemented by aspects of the wireless communications system 100 and 200 as described with reference to FIGS. 1 and 2, respectively. For example, the resource diagram 300-a may be implemented by one or more UEs 115 to support PSFCH feedback and resource determination which may provide improvements to data rates, capacity, spectral efficiency, coordination between devices, resource utilization, reliability, sidelink scheduling efficiency, and latency, among other benefits.

The resource diagram 300-b depicts a sidelink resource pool that includes a quantity of TTIs 350 (e.g., a quantity of slots, a quantity of mini-slots) that each span a quantity of subchannels 355 (e.g., subchannel 355-a through subchannel 355-n). The resource diagram 300-b additionally depicts the sidelink resource pool as including PSFCHs 360 that occur in accordance with a PSFCH periodicity parameter. Each PSFCH 360 may include a set of PSFCH resources 365 and may span a slot or a mini-slot in the time domain.

The resource diagram 300-b depicts a transport block 345 that is communicated between a first UE 115 and a second UE (e.g., transmitted by the second UE 115 to the first UE 115) over a TTI 350-a, a TTI 350-b, a TTI 350-c, and a TTI 350-d. In the example of FIG. 3B, the first UE 115 may receive a single repetition of the transport block 345 over the TTIs 350-a through 350-d (e.g., in accordance with a type A reservation). The second UE 115 may transmit the transport block 345 over one or more subchannels 355. In some examples, the second UE 115 may transmit the transport block 345 over or using same or different subchannels 355 in each TTI 350 (e.g., in accordance with a frequency hopping scheme). In the example of FIG. 3B, the second UE 115 may transmit the transport block 345 over subchannel 355-n in the TTI 350-a and the TTI 350-b and over subchannel 355-a and subchannel 355-b in the TTI 350-c and the TTI 350-d.

The transport block 345 may span multiple feedback windows 380. For example, a first portion of the transport block 345 (e.g., corresponding to the TTI 350-a) may be communicated in a feedback window 380-a corresponding to a PSFCH 360-a and a second portion of the transport block 345 (e.g., corresponding to the TTIs 350-b through 350-d) may be communicated in a feedback window 380-b corresponding to a PSFCH 360-b (e.g., although it is possible for additional portions of the transport block 345 to be communicated in additional feedback windows 380 corresponding to additional PSFCHs 360). In some examples, a feedback window 380 may be a duration of time before a given PSFCH 360 during which received PSSCH transmissions will be mapped to the given PSFCH 360. In some examples, a feedback window 380 may be based on a configured minimum time gap. For example, if the first UE 115 and the second UE 115 are configured with a gap 375 corresponding to a single TTI gap, a feedback window 380 may correspond to the TTIs 350 prior to the minimum time gap before a given PSFCH 360 and after a PSFCH 360 previous to the given PSFCH 360 and a temporally last TTI 350 prior to the PSFCH 360 previous to the given PSFCH 360. For instance, the feedback window 380-a may correspond to the TTIs 350 prior to the minimum time gap before the PSFCH 360-a, and the feedback window 380-b may correspond to the TTIs 350 after the PSFCH 360-a and before the gap 375 and the TTI 350-b corresponding to the temporally last TTI 350 prior to the PSFCH 360-a.

The first UE 115 may refrain from generating and transmitting feedback pertaining to reception of the transport block 345 until after receiving an entirety of the transport block 345. That is, the first UE 115 may receive the first portion of the transport block in the feedback window 380-a over the TTI 350-a. Receiving PSSCH transmissions in the feedback window 380-a may indicate for the first UE 115 to generate corresponding feedback and transmit the feedback in one or more resources of the PSFCH 360-a. However, the first UE 115 may instead wait until receiving an entirety of the transport block 345 in the TTI 350-d to generate and transmit the feedback in the PSFCH 360-b corresponding to the feedback window 380-b, for example, based on the transport block 345 including a single repetition. That is, feedback generated based on receiving the first portion of the transport block 345 may be an inaccurate indication of whether the first UE 115 successfully received the transport block 345, and thus, the first UE 115 may wait to receive the entirety of the transport block 345 to generate and transmit the feedback in a PSFCH 360 corresponding to a last feedback window 380 in which the transport block 345 is received.

The first UE 115 may determine which one or more PSFCH resources 370 of the set of PSFCH resources 365 included in the PSFCH 360-b to use to transmit the generated feedback in accordance with a rule. The second UE 115 may additionally determine the one or more PSFCH resources 370 in accordance with the rule in order to determine over which PSFCH resources 370 to receive the generated feedback. For example, the rule may indicate for the first UE 115 and the second UE 115 to identify a temporally last TTI 350 of the transport block 345 to use in determining the one or more PSFCH resources 370 (e.g., based on communicating the transport block 345 in accordance with a type A reservation). Accordingly, the first UE 115 and the second UE 115 may identify the TTI 350-d and may use an index of the TTI 350-d and an index of the starting subchannel 355 of the TTI 350-d (e.g., an index of the subchannel 355-a) or a quantity of subchannels 355 used to transmit the transport block in the TTI 350-d to determine the one or more PSFCH resources 330.

Alternatively, the rule may indicate for the first UE 115 and the second UE 115 to identify a temporally first TTI 350 of the transport block 345 to use in determining the one or more PSFCH resources 370 (e.g., based on communicating the transport block 345 in accordance with a type A reservation). Accordingly, the first UE 115 and the second UE 115 may identify the TTI 350-a and may use an index of the TTI 350-a and an index of the starting subchannel 355 of the TTI 350-a (e.g., an index of the subchannel 355-n) or a quantity of subchannels 355 used to transmit the transport block in the TTI 350-a to determine the one or more PSFCH resources 370.

In some examples, the first UE 115 and the second UE 115 may determine the one or more PSFCH resource 370 based on a quantity of HARQ feedback bits generated. For example, the first UE 115 and the second UE 115 may determine, in accordance with the rule, a single PSFCH resource 370 (e.g., a PSFCH resource 370-a) of the set of PSFCH resources 365 to communicate the HARQ feedback bit if the first UE 115 is configured to generate a single HARQ feedback bit. Alternatively, the first UE 115 may be configured to generate the HARQ feedback bit for each TTI 350 over which the transport block 345 is received. Accordingly, based on receiving the transport block 345 over four TTIs 350, the first UE 115 may generate the HARQ feedback bit four times and determining four PSFCH resources 370 (e.g., the PSFCH resource 370-a, a PSFCH resource 370-b, a PSFCH resource 370-c, and a PSFCH resource 370-d)) of the set of PSFCH resources 365 to communicate the HARQ feedback bits. In some examples, the first UE 115 and the second UE 115 may use each of the TTIs 350 (e.g., TTI indexes and starting subchannel indexes or subchannel quantities) to determine a corresponding PSFCH resource 370.

The first UE 115 may transmit the generated feedback to the second UE over or using the one or more determined PSFCH resource 370. In some examples, if the first UE 115 generates multiple HARQ feedback bits, the first UE 115 may transmit each HARQ feedback bit using a different cyclic shift within non-overlapping PRBs. In some examples, the first UE 115 may transmit each HARQ feedback bit using a same cyclic shift sequence corresponding to the transport block 345 in each determined PSFCH resource 370.

FIG. 4A illustrates an example of a resource diagram 400-a that supports techniques for sidelink feedback channel resource determination in accordance with aspects of the present disclosure. The resource diagram 400-a may be implemented by aspects of the wireless communications system 100 and 200 as described with reference to FIGS. 1 and 2, respectively. For example, the resource diagram 400-a may be implemented by one or more UEs 115 to support PSFCH feedback and resource determination which may provide improvements to data rates, capacity, spectral efficiency, coordination between devices, resource utilization, reliability, sidelink scheduling efficiency, and latency, among other benefits.

The resource diagram 400-a depicts a sidelink resource pool that includes a quantity of TTIs 410 (e.g., a quantity of slots, a quantity of mini-slots) that each span a quantity of subchannels 415 (e.g., subchannel 415-a through subchannel 415-n). The resource diagram 400-a additionally depicts the sidelink resource pool as including a PSFCH 420 that occurs in accordance with a PSFCH periodicity parameter. The PSFCH 420 may include a set of PSFCH resources 425 and may span a slot or a mini-slot in the time domain.

The resource diagram 400-a depicts a transport block 405 that is communicated between a first UE 115 and a second UE (e.g., transmitted by the second UE 115 to the first UE 115) over a TTI 410-a, a TTI 410-b, and a TTI 410-c. In the example of FIG. 4A, the first UE 115 may receive multiple repetitions R of the transport block 405 over the TTIs 410-a through 410-c (e.g., in accordance with a type B reservation). For example, the first UE 115 may receive a first repetition R1 of the transport block 405 over the TTI 410-a, a second repetition R2 of the transport block 405 over the TTI 410-b, and a third repetition R3 of the transport block 405 over the TTI 410-c. The second UE 115 may transmit the transport block 405 over one or more subchannels 415. In some examples, the second UE 115 may transmit each repetition R of the transport block 405 over or using same or different subchannels 415 in each TTI 410 (e.g., in accordance with a frequency hopping scheme). In the example of FIG. 4A, the second UE 115 may transmit R1 and R2 over subchannel 415-b and subchannel 415-c and R3 over subchannel 415-a and subchannel 415-b.

In response to receiving the transport block 405, the first UE 115 may generate feedback pertaining to reception of the transport block 405. For example, the first UE 115 may generate acknowledgement information that indicates whether the first UE 115 successfully received the transport block 405. In some examples, the first UE 115 may generate the acknowledgement information based on a final decision of receiving the transport block 405. That is, the first UE 115 may generate the acknowledgement information based on a combination of R1, R2, and R3. For example, the first UE 115 may decode R1, R2, and R3 and may determine whether the transport block 405 was successfully received based on a combination of the data decoded in R1, R2, and R3. In some cases, the first UE 115 may generate a single HARQ feedback bit indicating an ACK or a NACK corresponding to the final decision. In some other examples, the first UE 115 may generate multiple HARQ feedback bits that each indicate the ACK or the NACK corresponding to the final decision.

In some other examples, the first UE 115 may generate acknowledgement information for each repetition R. For example, the first UE 115 may decode R1, R2, and R3 individually, determine whether each repetition R was successfully received, and generate an individual HARQ feedback bit for each repetition R. In some cases, if one or more of the HARQ feedback bits indicates an ACK for a corresponding repetition R, the second UE 115 may determine that the UE 115 successfully received the transport block 405.

The first UE 115 may determine which one or more PSFCH resources 430 of the set of PSFCH resource 425 to use to transmit the generated feedback in accordance with a rule. The second UE 115 may additionally determine the one or more PSFCH resources 430 in accordance with the rule in order to determine over which PSFCH resources 430 to receive the generated feedback. If a single HARQ feedback bit is generated and transmitted to the second UE 115, the rule may indicate for the first UE 115 and the second UE 115 to identify a temporally last TTI 410 of the transport block 405 to use in determining a PSFCH resource 430 (e.g., based on communicating the transport block 405 in accordance with a type B reservation). Accordingly, the first UE 115 and the second UE 115 may identify the TTI 410-c and may use an index of the TTI 410-c and an index of the starting subchannel 415 of the TTI 410-c (e.g., an index of the subchannel 415-a) or a quantity of subchannels 415 used to transmit the transport block in the TTI 410-c to determine the PSFCH resource 430 (e.g., a PSFCH resource 430-a).

Alternatively, if a single HARQ feedback bit is generated and transmitted to the second UE 115, the rule may indicate for the first UE 115 and the second UE 115 to identify a temporally first TTI 410 of the transport block 405 to use in determining the PSFCH resource 430 (e.g., based on communicating the transport block 405 in accordance with a type B reservation). Accordingly, the first UE 115 and the second UE 115 may identify the TTI 410-a and may use an index of the TTI 410-a and an index of the starting subchannel 415 of the TTI 410-a (e.g., an index of the subchannel 415-b) or a quantity of subchannels 415 used to transmit the transport block in the TTI 410-a to determine the PSFCH resource 430.

Alternatively, if a single HARQ feedback bit is generated and transmitted to the second UE 115, the rule may indicate for the first UE 115 and the second UE 115 to identify a slot containing the TTIs 410-a through 410-c to use in determining the PSFCH resource 430 (e.g., based on communicating the transport block 345 in accordance with a type B reservation). For example, if the TTIs 410 correspond to mini-slots and at least the TTIs 410 over which the transport block 405 are transmitted are included in a same slot, the rule may indicate for the first UE 115 and the second UE 115 to use an index of the slot to determine the PSFCH resource 430.

In some examples, if multiple HARQ feedback bits are generated, the rule may indicate for the first UE 115 and the second UE 115 to determine a PSFCH resource 430 corresponding to each TTI 410 over which the transport block 405 is received. For example, for each of the TTI 410-a, 410-b, and 410-c, the first UE 115 and the second UE 115 may use a corresponding TTI index and a corresponding starting subchannel index or a corresponding subchannel quantity to determine a PSFCH resource 430 for transmitting a HARQ feedback bit (e.g., a repeated HARQ feedback bit corresponding to the final decision, an individual HARQ feedback bit corresponding to the repetition R). For instance, the first UE 115 and the second UE 115 may determine a PSFCH resource 430-a corresponding to the TTI 410-a, a PSFCH resource 430-b corresponding to the TTI 410-b, and a PSFCH resource 430-c corresponding to the TTI 410-c.

In some cases, one or more of the determined PSFCH resources 430 may overlap (e.g., be the same). For example, the first UE 115 and the second UE 115 may determine that there are fewer PSFCH resources 430 available for transmitting the HARQ feedback bits than there are HARQ feedback bits. For instance, the first UE 115 and the second UE 115 may determine that there are two PRBs corresponding to PSFCH resource 430-a and PSFCH resource 430-b allocated for communicating the HARQ feedback bits. Here, the PSFCH resource 430-a may have a PRB index of 0 and the PSFCH resources 430-b may have a PRB index of 1. To determine which TTI 410 corresponds to which PSFCH resource 430, the first UE 115 and the second UE 115 may determine that i = mod(sourceID + destID + TTI_{index}, x), where i is the PRB index of the corresponding PSFCH resource 430, sourceID is the source identifier of the second UE 115, destID is the destination identifier of the second UE 115, and x is the quantity of allocated PRBs. Accordingly, in this example, if sourceID + destID = 0, the first UE 115 and the second UE 115 may determine that i = 0 for TTI 410-a having a TTI_{index} of 0, that i = 1 for TTI 410-b having a TTI_{index} of 1, and that i = 0 for TTI 410-c having a TTI_{index} of 2. Accordingly, both the TTI 410-a and the TTI 410-c may be mapped to the PSFCH resource 430-a. In some examples, the first UE 115 may transmit both of the HARQ feedback bits corresponding to the TTI 410-a and the TTI 410-c over the PSFCH resource 430-a using different cyclic shifts. In some examples, the first UE 115 may transmit both of the HARQ feedback bits corresponding to the TTI 410-a and the TTI 410-c over the PSFCH resource 430-a using a same cyclic shift, which may correspond to transmitting the same HARQ feedback bit over the same PSFCH resource 430 using a same cyclic shift. In some examples, the first UE 115 may drop one of the HARQ feedback bits corresponding to the TTI 410-a or the TTI 410-c and transmit the other HARQ feedback bit using the PSFCH resource 430-a.

The rule may indicate for the first UE 115 to transmit the generated feedback in a next available PSFCH 420. That is, the first UE 115 may transmit the generated feedback in accordance with a configured minimum time gap. For instance, in the example of FIG. 4A, the first UE 115 and the second UE 115 may be configured with a gap 435 corresponding to a single TTI gap before the PSFCH 420. Accordingly, each of the repetitions R of the transport block 405 may occur within a feedback window corresponding to the PSFCH 420 as each of the repetitions R occur prior to the gap 435. Therefore, the first UE 115 may determine that the PSFCH 420 is the next available PSFCH and may transmit the generated feedback to the second UE 115 over or using the determined PSFCH resources 430 of the PSFCH 420.

FIG. 4B illustrates an example of a resource diagram 400-b that supports techniques for sidelink feedback channel resource determination in accordance with aspects of the present disclosure. The resource diagram 400-b may be implemented by aspects of the wireless communications system 100 and 200 as described with reference to FIGS. 1 and 2, respectively. For example, the resource diagram 400-b may be implemented by one or more UEs 115 to support PSFCH feedback and resource determination which may provide improvements to data rates, capacity, spectral efficiency, coordination between devices, resource utilization, reliability, sidelink scheduling efficiency, and latency, among other benefits.

The resource diagram 400-b depicts a sidelink resource pool that includes a quantity of TTIs 445 (e.g., a quantity of slots, a quantity of mini-slots) that each span a quantity of subchannels 450 (e.g., subchannel 450-a through subchannel 450-n). The resource diagram 400-b additionally depicts the sidelink resource pool as including PSFCHs 455 that occur in accordance with a PSFCH periodicity parameter. For example, in accordance with the PSFCH periodicity parameter, the sidelink resource pool may include a PSFCH 455-a that occurs after a TTI 445-d and a PSFCH 455-b that occurs after a TTI 445-h. Each PSFCH 455 may include a set of PSFCH resources and may span a slot or a mini-slot in the time domain. For example, the PSFCH 455-a may include a set of PSFCH resources 470 and the PSFCH 455-b may include a set of PSFCH resources 480.

The resource diagram 400-b depicts a transport block 440 that is communicated between a first UE 115 and a second UE (e.g., transmitted by the second UE 115 to the first UE 115) over a TTI 445-a, a TTI 445-b, a TTI 410-c, the TTI 445-d, a TTI 445-e, a TTI 445-f, a TTI 410-g, and the TTI 445-h. In the example of FIG. 4B, the first UE 115 may receive multiple repetitions R of the transport block 405 over the TTIs 445-a through 445-h (e.g., in accordance with a type B reservation). For example, the first UE 115 may receive a first repetition R1 of the transport block 440 over the TTI 445-a, a second repetition R2 of the transport block 440 over the TTI 445-b, a third repetition R3 of the transport block 440 over the TTI 445-c, a fourth repetition R4 of the transport block 440 over the TTI 445-d, a fifth repetition R5 of the transport block 440 over the TTI 445-e, a sixth repetition R6 of the transport block 440 over the TTI 445-f, a seventh repetition R7 of the transport block 440 over the TTI 445-g, and an eighth repetition R8 of the transport block 440 over the TTI 445-h. The second UE 115 may transmit the transport block 440 over one or more subchannels 450. In some examples, the second UE 115 may transmit each repetition R of the transport block 440 over or using same or different subchannels 450 in each TTI 445 (e.g., in accordance with a frequency hopping scheme). In the example of FIG. 4B, the second UE 115 may transmit R1, R2, R7, and R8 over subchannel 450-b and subchannel 450-c and R3, R4, R5, and R6 over subchannel 450-a and subchannel 450-b.

The transport block 440 may span multiple feedback windows 490. For example, R1, R2, and R3 may occur within a feedback window 490-a corresponding to the PSFCH 455-a based on occurring prior to a gap 460. R4, R5, R6, and R7 may occur within a feedback window 490-b corresponding to PSFCH 455-b based on occurring after the gap 460 and prior to a gap 465. R8 may occur within a feedback window 490-c corresponding to a subsequent PSFCH 455 (not shown) based on occurring after the gap 465.

The first UE 115 may generate feedback corresponding to each feedback window 490 (e.g., or a combination of feedback windows 490). For example, the first UE 115 may generate feedback first acknowledgement information associated with R1, R2, and R3 (e.g., one or more HARQ feedback bits corresponding to a final decision of a combination of R1, R2, R3, HARQ feedback bits corresponding to each of R1, R2, and R3) based on receiving R1, R2, and R3 during the feedback window 490-a. In some examples, the first UE 115 may generate second acknowledgement information associated with R4, R5, R6, and R7 (e.g., one or more HARQ feedback bits corresponding to a final decision of a combination of R4, R5, R6, and R7, HARQ feedback bits corresponding to each of R4, R5, R6, and R7) based on receiving R4, R5, R6, and R7 during the feedback window 490-b. In some examples, the first UE 115 may generate the second acknowledgement information based on R1, R2, R3, R4, R5, R6, and R7 (e.g., one or more HARQ feedback bits corresponding to a final decision of a combination of R1, R2, R3, R4, R5, R6, and R7). In some cases, the first UE 115 may also generate third acknowledgement information associated with R8 based on receiving R8 during the feedback window 490-c. In some cases, the first UE 115 may generate the third acknowledgement information based on R1, R2, R3, R4, R5, R6, R7, and R8 (e.g., one or more HARQ feedback bits corresponding to a final decision of a combination of R1, R2, R3, R4, R5, R6, R7, R8).

Based on generating feedback, the first UE 115 and the second UE 115 may determine one or more PSFCH resources 475 of the PSFCH 455-a to transmit the first acknowledgement information and one or more PSFCH resources 485 of the PSFCH 455-b to transmit the second acknowledgement information (e.g., and one or more PSFCH resources of a subsequent PSFCH 455 to transmit the third acknowledgement information) in accordance with a rule. The first UE 115 and the second UE 115 may determine the PSFCH resources based on whether a single or multiple HARQ feedback bits are generated. For example, if a single HARQ feedback bit is generated and transmitted to the second UE 115, the rule may indicate for the first UE 115 and the second UE 115 to identify a temporally last TTI 445 of each feedback window 490 to use in determining a PSFCH resource (e.g., a TTI 445-c of feedback window 490-a, a TTI 445-g of feedback window 490-b) and use the corresponding TTI index and starting subchannel index or subchannel quantity to determine the PSFCH resource (e.g., a PSFCH resource 475-c, a PSFCH resource 485-d).

Alternatively, if a single HARQ feedback bit is generated and transmitted to the second UE 115, the rule may indicate for the first UE 115 and the second UE 115 to identify a temporally first TTI 445 of each feedback window 490 to use in determining a PSFCH resource (e.g., a TTI 445-a of feedback window 490-a, a TTI 445-d of feedback window 490-b) and use the corresponding TTI index and starting subchannel index or subchannel quantity to determine the PSFCH resource (e.g., a PSFCH resource 475-a, a PSFCH resource 485-a).

In some examples, if multiple HARQ feedback bits are generated, the rule may indicate for the first UE 115 and the second UE 115 to determine a PSFCH resource corresponding to each TTI 445 over which the transport block 405 is received. For example, for each of the TTIs 445-a through 445-h, the first UE 115 and the second UE 115 may use a corresponding TTI index and a corresponding starting subchannel index or a corresponding subchannel quantity to determine a PSFCH resource (e.g., a PSFCH resource 475, a PSFCH resource 485) for transmitting a HARQ feedback bit (e.g., a repeated HARQ feedback bit corresponding to the final decision, an individual HARQ feedback bit corresponding to the repetition R). For instance, the first UE 115 and the second UE 115 may determine a PSFCH resource 475-a corresponding to the TTI 445-a, a PSFCH resource 475-b corresponding to the TTI 445-b, and a PSFCH resource 475-c corresponding to the TTI 445-c for the feedback window 490-a. Additionally, the first UE 115 and the second UE 115 may determine a PSFCH resource 485-a corresponding to the TTI 445-d, a PSFCH resource 485-b corresponding to the TTI 445-e, a PSFCH resource 485-c corresponding to the TTI 445-f, and a PSFCH resource 485-d corresponding to the TTI 445-g for the feedback window 490-b.

In some examples, one or more of the determined PSFCH resources may overlap (e.g., be the same). In some cases, the first UE 115 may transmit multiple HARQ feedback bits corresponding to the generated acknowledgement information in overlapping PSFCH resources using different cyclic shifts. In some cases, the first UE 115 may transmit the multiple HARQ feedback bits in overlapping PSFCH resources using same cyclic shifts. Here, transmitting multiple HARQ feedback bits in an overlapping PSFCH resource using a same cyclic shift may result in transmitting a same single HARQ feedback bit over the same PSFCH resource using the same cyclic shift. In some cases, the first UE 115 may drop one of more of the HARQ feedback bits in the overlapping PSFCH resources.

In some examples, the first UE 115 may generate and transmit feedback associated with each feedback window 490 based on the rule indicating for the first UE 115 to transmit feedback in a next available PSFCH 455. For example, because the PSFCH 455-a corresponds to the next available PSFCH 455 for R1, R2, and R3, the first UE 115 may generate and transmit the first acknowledgement information over the PSFCH 455-a. Additionally, because the PSFCH 455-b corresponds to the next available PSFCH 455 for R4, R5, R6, and R7, the first UE 115 may generate and transmit the second acknowledgement information over the PSFCH 455-b, and so on.

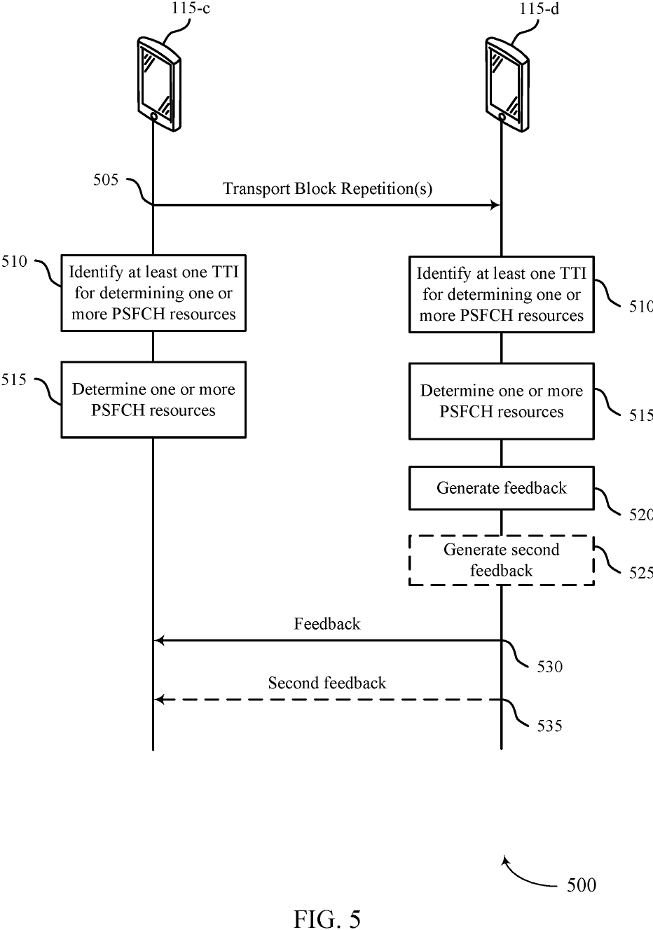

FIG. 5 illustrates an example of a process flow 500 that supports techniques for sidelink feedback channel resource determination in accordance with aspects of the present disclosure. The process flow 500 may implement aspects of the wireless communications systems 100 and 200 or may be implemented by aspects of the wireless communications system 100 and 200 as described with reference to FIGS. 1 and 2, respectively. For example, the process flow 500 may be implemented by a UE 115-c and a UE 115-d to support PSFCH feedback and resource determination which may provide improvements to data rates, capacity, spectral efficiency, coordination between devices, resource utilization, reliability, sidelink scheduling efficiency, and latency, among other benefits.

The UE 115-c and the UE 115-d may be examples of a UE 115, as described with reference to FIGS. 1, 2, 3A, 3B, 4A, or 4B. In the following description of the process flow 500, the operations may be performed in different orders or at different times. Some operations may also be omitted from the process flow 500, and other operations may be added to the process flow 500.

At 505, the UE 115-c may transport one or more repetitions of a transport block to the UE 115-d that together span multiple TTIs. For example, the UE 115-c may transport a single repetition of the transport block that spans the multiple TTIs (e.g., in accordance with a type A reservation). Alternatively, the UE 115-c may transmit multiple repetitions of the transport block over the multiple TTIs, each repetition transmitted in a different TTI of the multiple TTI.

At 510, each of the UE 115-c and the UE 115-d may identify at least one TTI of the multiple TTIs to use in determining one or more PSFCH resources for providing feedback pertaining to reception of the one or more repetitions of the transport block. The UE 115-c and the UE 115-d may identify the at least one TTI in accordance with a rule as described herein. For example, the UE 115-c and the UE 115-d may identify a temporally last TTI or a temporally first TTI in accordance with the rule, among other options described herein.

At 515, each of the UE 115-c and the UE 115-d may determine the one or more PSFCH resources based on an index (e.g., or indexes) of the at least one TTI. For example, the UE 115-c and the UE 115-d may use the index of the at least one TTI to map the one or more repetitions of the transport block to corresponding PSFCH resources. In some examples, the UE 115-c and the UE 115-d may additionally use a starting subchannel index of the transport block within the at least one TTI or a quantity of PSSCH subchannels within the at least one TTI.

At 520, the UE 115-c may generate the feedback pertaining to the reception of the one or more repetitions of the transport block. In some examples, the UE 115-c may generate acknowledgement information (e.g., including one or multiple HARQ feedback bits) that indicates whether the single repetition of the transport block was successfully received. In some examples, the UE 115-c may generate acknowledgement information (e.g., including one or multiple HARQ feedback bits) that indicates whether the transport block was successfully received based on a combination of data decoded from receiving the multiple repetitions of the transport block. In some examples, the UE 115-c may generate acknowledgement information that indicates whether each of the multiple repetitions was successfully received.

At 525, the UE 115-c may generate second feedback pertaining to the reception of the one or more repetitions of the transport block. For example, if multiple repetitions of the transport block span multiple feedback windows, the UE 115-c may generate feedback to transmit in each PSFCH occasion corresponding to each feedback window. Here, the determined one or more resources may correspond to a first PSFCH, and the UE 115-c and the UE 115-d may determine one or more resources of a second PSFCH to transmit the second feedback based on an index (e.g., or indexes) of the TTIs occurring in a second feedback window different than a first feedback window associated with the first PSFCH.

At 530, the UE 115-c may transmit the feedback to the UE 115-d over or using the one or more resources of the PSFCH (e.g., associated with the first feedback window).

At 535, the UE 115-c may transmit the second feedback to the UE 115-d over or using the one or more resources of the second PSFCH associated with the second feedback window.

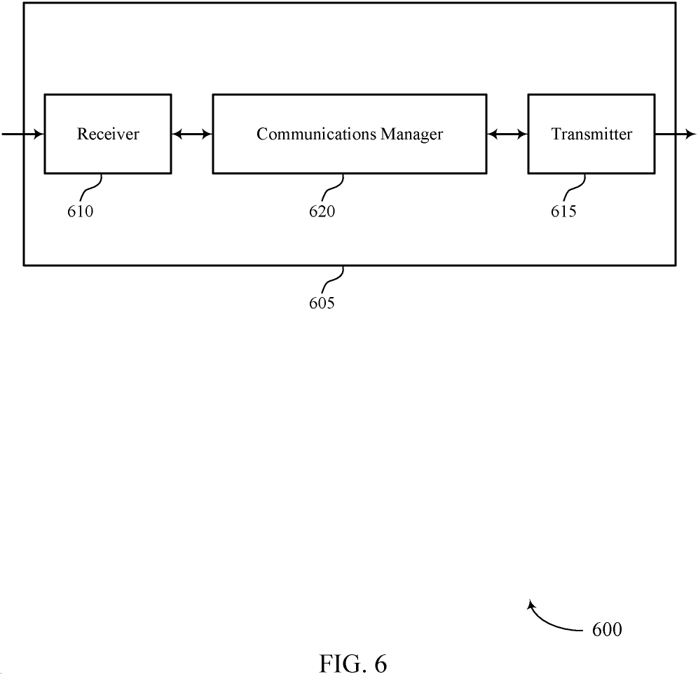

FIG. 6 shows a block diagram 600 of a device 605 that supports techniques for sidelink feedback channel resource determination in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for sidelink feedback channel resource determination). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for sidelink feedback channel resource determination). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for sidelink feedback channel resource determination as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. For example, the communications manager 620 may be configured as or otherwise support a means for receiving, from a second UE over a sidelink channel, one or more repetitions of a transport block that together span a set of multiple TTIs. The communications manager 620 may be configured as or otherwise support a means for identifying, in accordance with a rule, at least one of the set of multiple TTIs to be used in determining one or more resources of a sidelink feedback channel for providing feedback pertaining to reception of the one or more repetitions of the transport block. The communications manager 620 may be configured as or otherwise support a means for determining the one or more resources of the sidelink feedback channel based on an index of the at least one of the set of multiple TTIs. The communications manager 620 may be configured as or otherwise support a means for transmitting the feedback to the second UE over the one or more resources of the sidelink feedback channel.

Additionally or alternatively, the communications manager 620 may support wireless communication at a first UE in accordance with examples as disclosed herein. For example, the communications manager 620 may be configured as or otherwise support a means for transmitting, to a second UE over a sidelink channel, one or more repetitions of a transport block that together span a set of multiple TTIs. The communications manager 620 may be configured as or otherwise support a means for identifying, in accordance with a rule, at least one of the set of multiple TTIs to be used in determining one or more resources of a sidelink feedback channel for receiving feedback pertaining to transmission of the one or more repetitions of the transport block. The communications manager 620 may be configured as or otherwise support a means for determining the one or more resources of the sidelink feedback channel based on an index of the at least one of the set of multiple TTIs. The communications manager 620 may be configured as or otherwise support a means for receiving the feedback from the second UE over the one or more resources of the sidelink feedback channel.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for improved resource utilization and spectral efficiency by supporting the communication of sidelink feedback in response to communicating one or more repetitions of a transport block over multiple TTIs.

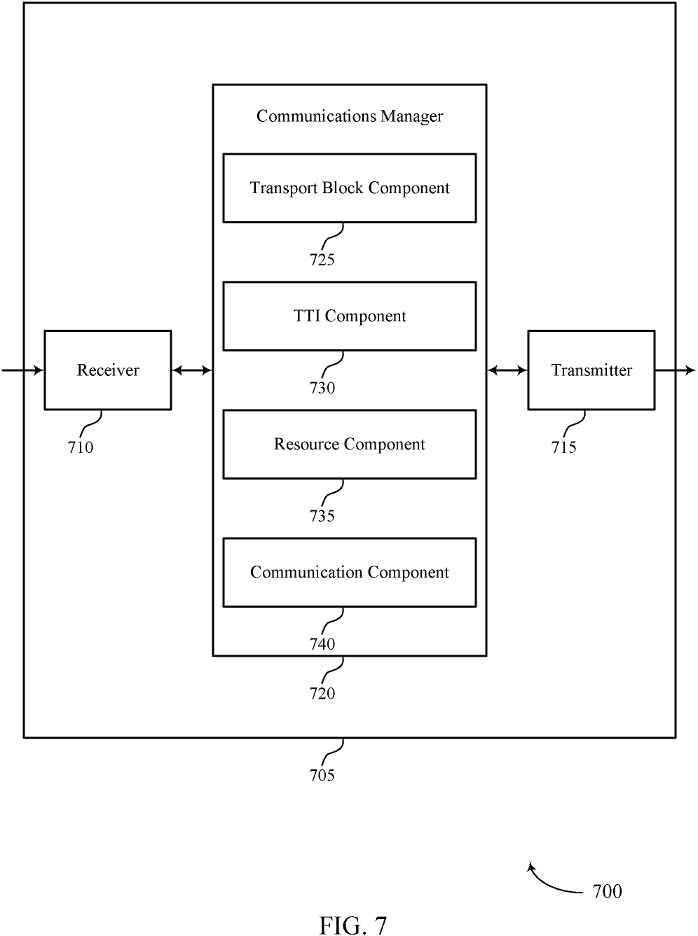

FIG. 7 shows a block diagram 700 of a device 705 that supports techniques for sidelink feedback channel resource determination in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for sidelink feedback channel resource determination). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for sidelink feedback channel resource determination). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for sidelink feedback channel resource determination as described herein. For example, the communications manager 720 may include a transport block component 725, a TTI component 730, a resource component 735, a communication component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. The transport block component 725 may be configured as or otherwise support a means for receiving, from a second UE over a sidelink channel, one or more repetitions of a transport block that together span a set of multiple TTIs. The TTI component 730 may be configured as or otherwise support a means for identifying, in accordance with a rule, at least one of the set of multiple TTIs to be used in determining one or more resources of a sidelink feedback channel for providing feedback pertaining to reception of the one or more repetitions of the transport block. The resource component 735 may be configured as or otherwise support a means for determining the one or more resources of the sidelink feedback channel based on an index of the at least one of the set of multiple TTIs. The communication component 740 may be configured as or otherwise support a means for transmitting the feedback to the second UE over the one or more resources of the sidelink feedback channel.

Additionally or alternatively, the communications manager 720 may support wireless communication at a first UE in accordance with examples as disclosed herein. The transport block component 725 may be configured as or otherwise support a means for transmitting, to a second UE over a sidelink channel, one or more repetitions of a transport block that together span a set of multiple TTIs. The TTI component 730 may be configured as or otherwise support a means for identifying, in accordance with a rule, at least one of the set of multiple TTIs to be used in determining one or more resources of a sidelink feedback channel for receiving feedback pertaining to transmission of the one or more repetitions of the transport block. The resource component 735 may be configured as or otherwise support a means for determining the one or more resources of the sidelink feedback channel based on an index of the at least one of the set of multiple TTIs. The communication component 740 may be configured as or otherwise support a means for receiving the feedback from the second UE over the one or more resources of the sidelink feedback channel.

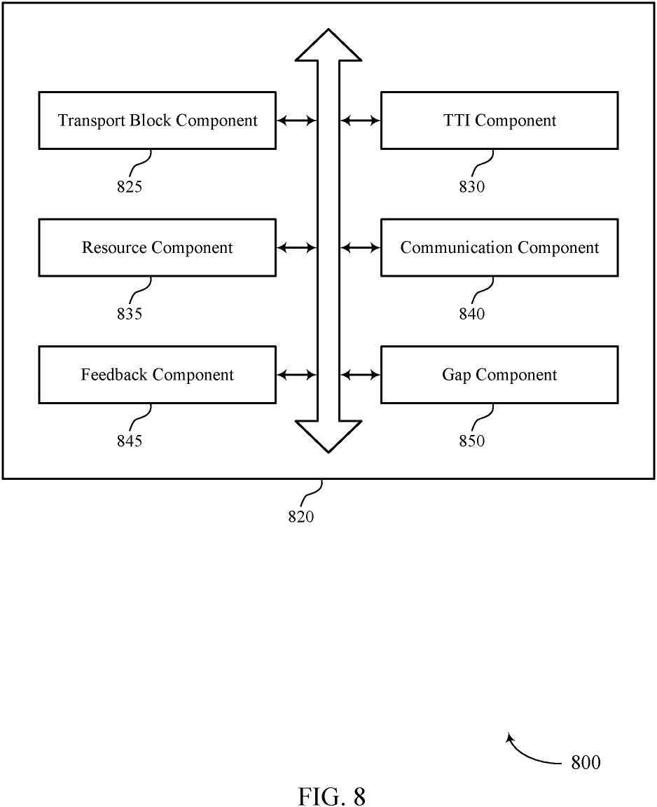

FIG. 8 shows a block diagram 800 of a communications manager 820 that supports techniques for sidelink feedback channel resource determination in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for sidelink feedback channel resource determination as described herein. For example, the communications manager 820 may include a transport block component 825, a TTI component 830, a resource component 835, a communication component 840, a feedback component 845, a gap component 850, or any combination thereof. Each of these components may communicate, directly or indirectly, with one another (e.g., via one or more buses).

The communications manager 820 may support wireless communication at a first UE in accordance with examples as disclosed herein. The transport block component 825 may be configured as or otherwise support a means for receiving, from a second UE over a sidelink channel, one or more repetitions of a transport block that together span a set of multiple TTIs. The TTI component 830 may be configured as or otherwise support a means for identifying, in accordance with a rule, at least one of the set of multiple TTIs to be used in determining one or more resources of a sidelink feedback channel for providing feedback pertaining to reception of the one or more repetitions of the transport block. The resource component 835 may be configured as or otherwise support a means for determining the one or more resources of the sidelink feedback channel based on an index of the at least one of the set of multiple TTIs. The communication component 840 may be configured as or otherwise support a means for transmitting the feedback to the second UE over the one or more resources of the sidelink feedback channel.

In some examples, to support receiving the one or more repetitions of the transport block, the transport block component 825 may be configured as or otherwise support a means for receiving a single repetition of the transport block that spans the set of multiple TTIs, where identifying the at least one of the set of multiple TTIs is based on receiving the single repetition of the transport block.

In some examples, to support identifying the at least one of the set of multiple TTIs, the TTI component 830 may be configured as or otherwise support a means for identifying, in accordance with the rule, that all of the set of multiple TTIs are to be used in determining the one or more resources of the sidelink feedback channel, where the feedback includes a quantity of feedback bits corresponding to a quantity of TTIs included in the set of multiple TTIs, each feedback bit representing the feedback for the single repetition of the transport block.

In some examples, to support receiving the one or more repetitions of the transport block, the transport block component 825 may be configured as or otherwise support a means for receiving the one or more repetitions of the transport block during multiple feedback windows of time, each feedback window associated with a respective sidelink feedback channel occasion, where the sidelink feedback channel on which the feedback is transmitted is associated with a temporally last sidelink feedback channel occasion of the respective sidelink feedback channel occasions.

In some examples, the feedback component 845 may be configured as or otherwise support a means for generating the feedback after an entirety of the single repetition of the transport block is received.

In some examples, to support receiving the one or more repetitions of the transport block, the transport block component 825 may be configured as or otherwise support a means for receiving a set of multiple repetitions of the transport block that together span the set of multiple TTIs, each repetition of the set of multiple repetitions received over a different TTI of the set of multiple TTIs, where identifying the at least one of the set of multiple TTIs is based on receiving the set of multiple repetitions of the transport block.

In some examples, the feedback component 845 may be configured as or otherwise support a means for generating acknowledgement information indicating whether the first UE successfully received the transport block based on decoding the set of multiple repetitions of the transport block, where the feedback includes the acknowledgement information.

In some examples, to support determining the one or more resources of the sidelink feedback channel, the resource component 835 may be configured as or otherwise support a means for determining, for each TTI of the set of multiple TTIs, a resource of the sidelink feedback channel based on an index of the TTI and based on a starting subchannel index of the transport block within the TTI or a quantity of subchannels associated with a sidelink shared channel included in the TTI. In some examples, to transmit the feedback to the second UE, the communication component 840 may be configured as or otherwise support a means for transmitting the acknowledgement information over each resource of the sidelink feedback channel determined for each TTI.

In some examples, the feedback component 845 may be configured as or otherwise support a means for generating, for each repetition of the set of multiple repetitions of the transport block, acknowledgement information indicating whether the first UE successfully received the repetition, where the feedback includes respective acknowledgement information for each repetition, and where a respective resource of the sidelink feedback channel used to transmit the respective acknowledgement information is determined based on an index of a respective TTI and based on a starting subchannel index of the transport block within the respective TTI or a quantity of subchannels associated with a sidelink shared channel included in the respective TTI.

In some examples, the gap component 850 may be configured as or otherwise support a means for determining that a first subset of repetitions of the set of multiple repetitions is received before a minimum time gap before a first sidelink feedback channel occasion and that a second subset of repetitions of the set of multiple repetitions is received after the minimum time gap. In some examples, the feedback component 845 may be configured as or otherwise support a means for generating first acknowledgement information indicating whether the first UE successfully received the first subset of repetitions based on decoding the first subset of repetitions, where the feedback includes the first acknowledgement information and the sidelink feedback channel corresponding to the first sidelink feedback channel occasion. In some examples, the feedback component 845 may be configured as or otherwise support a means for generating second acknowledgement information indicating whether the first UE successfully received the transport block based on decoding the first subset of repetitions and the second subset of repetitions. In some examples, the communication component 840 may be configured as or otherwise support a means for transmitting second feedback to the second UE including the second acknowledgement information over one or more resources of a second sidelink feedback channel corresponding to a second sidelink feedback channel occasion subsequent to the first sidelink feedback channel occasion.

In some examples, to support identifying the at least one of the set of multiple TTIs, the TTI component 830 may be configured as or otherwise support a means for identifying, in accordance with the rule, a temporally last TTI of the set of multiple TTIs, where determining the one or more resources of the sidelink feedback channel is based on an index of the temporally last TTI and based on a starting subchannel index of the transport block within the temporally last TTI or a quantity of subchannels associated with a sidelink shared channel included in the temporally last TTI.

In some examples, to support identifying the at least one of the set of multiple TTIs, the TTI component 830 may be configured as or otherwise support a means for identifying, in accordance with the rule, a temporally first TTI of the set of multiple TTIs, where determining the one or more resources of the sidelink feedback channel is based on an index of the temporally first TTI and based on a starting subchannel index of the transport block within the temporally first TTI or a quantity of subchannels associated with a sidelink shared channel included in the temporally first TTI.

In some examples, the set of multiple TTIs includes a set of multiple mini-slots included in a slot, the index of the at least one of the set of multiple TTIs corresponding to an index of the slot.

In some examples, to support receiving the one or more repetitions of the transport block, the transport block component 825 may be configured as or otherwise support a means for receiving the one or more repetitions of the transport block in accordance with a type of reservation associated with the set of multiple TTIs, where identifying the at least one of the set of multiple TTIs is based on the type of reservation.

In some examples, the resource component 835 may be configured as or otherwise support a means for determining the one or more resources of the sidelink feedback channel based on a respective starting subchannel index of the transport block within the at least one of the set of multiple TTIs or a respective quantity of subchannels associated with a sidelink shared channel included in the at least one of the set of multiple TTIs.

In some examples, the feedback includes a set of multiple feedback bits, each feedback bit transmitted using a different cyclic shift within non-overlapping resource blocks.

In some examples, the feedback includes a set of multiple feedback bits, each feedback bit transmitted using a same cyclic shift sequence per resource block.

In some examples, the set of multiple TTIs includes a set of multiple slots or a set of multiple mini-slots.

Additionally or alternatively, the communications manager 820 may support wireless communication at a first UE in accordance with examples as disclosed herein. In some examples, the transport block component 825 may be configured as or otherwise support a means for transmitting, to a second UE over a sidelink channel, one or more repetitions of a transport block that together span a set of multiple TTIs. In some examples, the TTI component 830 may be configured as or otherwise support a means for identifying, in accordance with a rule, at least one of the set of multiple TTIs to be used in determining one or more resources of a sidelink feedback channel for receiving feedback pertaining to transmission of the one or more repetitions of the transport block. In some examples, the resource component 835 may be configured as or otherwise support a means for determining the one or more resources of the sidelink feedback channel based on an index of the at least one of the set of multiple TTIs. In some examples, the communication component 840 may be configured as or otherwise support a means for receiving the feedback from the second UE over the one or more resources of the sidelink feedback channel.

In some examples, to support transmitting the one or more repetitions of the transport block, the transport block component 825 may be configured as or otherwise support a means for transmitting a single repetition of the transport block that spans the set of multiple TTIs, where identifying the at least one of the set of multiple TTIs is based on transmitting the single repetition of the transport block.

In some examples, to support transmitting the one or more repetitions of the transport block, the transport block component 825 may be configured as or otherwise support a means for transmitting a set of multiple repetitions of the transport block that together span the set of multiple TTIs, each repetition of the set of multiple repetitions transmitted over a different TTI of the set of multiple TTIs, where identifying the at least one of the set of multiple TTIs is based on transmitting the set of multiple repetitions of the transport block.

In some examples, to support transmitting the one or more repetitions of the transport block, the transport block component 825 may be configured as or otherwise support a means for transmitting the one or more repetitions of the transport block in accordance with a type of reservation associated with the set of multiple TTIs, where identifying the at least one of the set of multiple TTIs is based on the type of reservation.

In some examples, the resource component 835 may be configured as or otherwise support a means for determining the one or more resources of the sidelink feedback channel based on a respective starting subchannel index of the transport block within the at least one of the set of multiple TTIs or a respective quantity of subchannels associated with a sidelink shared channel included in the at least one of the set of multiple TTIs.

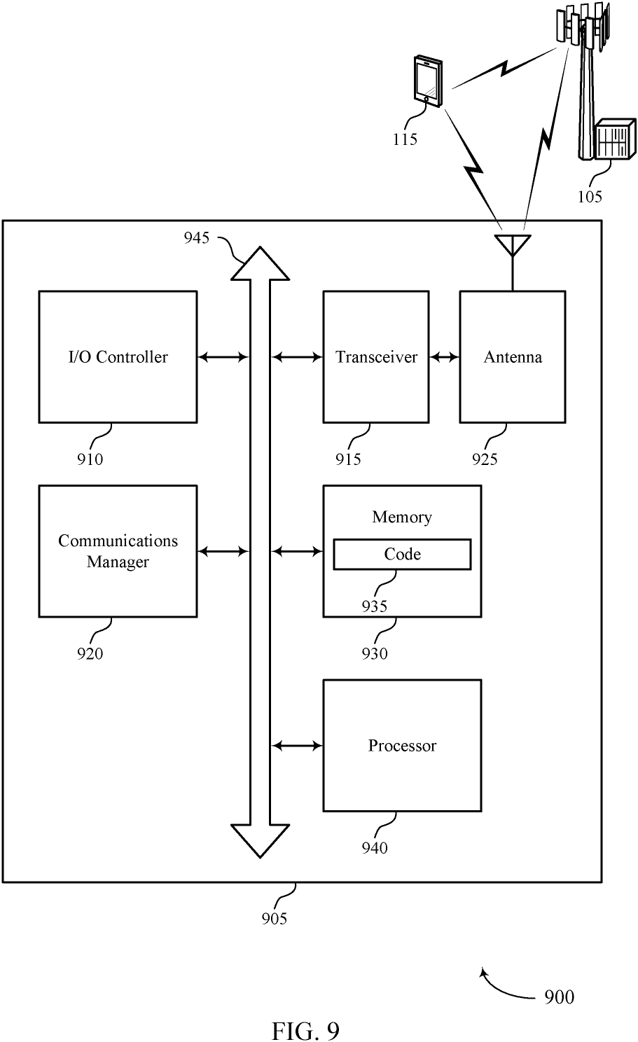

FIG. 9 shows a diagram of a system 900 including a device 905 that supports techniques for sidelink feedback channel resource determination in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for sidelink feedback channel resource determination). For example, the device 905 or a component of the device 905 may include a processor 940 and memory 930 coupled to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for receiving, from a second UE over a sidelink channel, one or more repetitions of a transport block that together span a set of multiple TTIs. The communications manager 920 may be configured as or otherwise support a means for identifying, in accordance with a rule, at least one of the set of multiple TTIs to be used in determining one or more resources of a sidelink feedback channel for providing feedback pertaining to reception of the one or more repetitions of the transport block. The communications manager 920 may be configured as or otherwise support a means for determining the one or more resources of the sidelink feedback channel based on an index of the at least one of the set of multiple TTIs. The communications manager 920 may be configured as or otherwise support a means for transmitting the feedback to the second UE over the one or more resources of the sidelink feedback channel.

Additionally or alternatively, the communications manager 920 may support wireless communication at a first UE in accordance with examples as disclosed herein. For example, the communications manager 920 may be configured as or otherwise support a means for transmitting, to a second UE over a sidelink channel, one or more repetitions of a transport block that together span a set of multiple TTIs. The communications manager 920 may be configured as or otherwise support a means for identifying, in accordance with a rule, at least one of the set of multiple TTIs to be used in determining one or more resources of a sidelink feedback channel for receiving feedback pertaining to transmission of the one or more repetitions of the transport block. The communications manager 920 may be configured as or otherwise support a means for determining the one or more resources of the sidelink feedback channel based on an index of the at least one of the set of multiple TTIs. The communications manager 920 may be configured as or otherwise support a means for receiving the feedback from the second UE over the one or more resources of the sidelink feedback channel.

By including or configuring the communications manager 920 in accordance with examples as described herein, the device 905 may support techniques for improved data rates, spectral efficiency, sidelink scheduling efficiency, reliability, coordination between devices, latency, and resource utilization, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for sidelink feedback channel resource determination as described herein, or the processor 940 and the memory 930 may be otherwise configured to perform or support such operations.

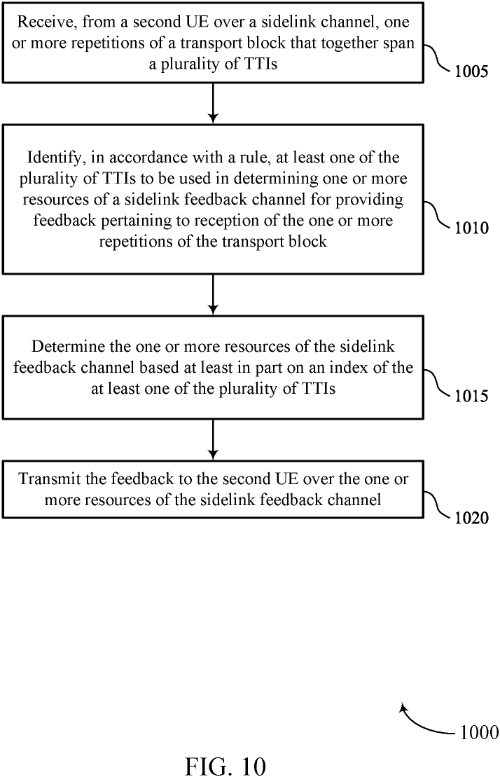

FIG. 10 shows a flowchart illustrating a method 1000 that supports techniques for sidelink feedback channel resource determination in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include receiving, from a second UE over a sidelink channel, one or more repetitions of a transport block that together span a plurality of TTIs. The operations of 1005 may be performed in accordance with examples as disclosed herein. In some examples, aspects of the operations of 1005 may be performed by a transport block component 825 as described with reference to FIG. 8.

At 1010, the method may include identifying, in accordance with a rule, at least one of the plurality of TTIs to be used in determining one or more resources of a sidelink feedback channel for providing feedback pertaining to reception of the one or more repetitions of the transport block. The operations of 1010 may be performed in accordance with examples as disclosed herein. In some examples, aspects of the operations of 1010 may be performed by a TTI component 830 as described with reference to FIG. 8.

At 1015, the method may include determining the one or more resources of the sidelink feedback channel based at least in part on an index of the at least one of the plurality of TTIs. The operations of 1015 may be performed in accordance with examples as disclosed herein. In some examples, aspects of the operations of 1015 may be performed by a resource component 835 as described with reference to FIG. 8.

At 1020, the method may include transmitting the feedback to the second UE over the one or more resources of the sidelink feedback channel. The operations of 1020 may be performed in accordance with examples as disclosed herein. In some examples, aspects of the operations of 1020 may be performed by a communication component 840 as described with reference to FIG. 8.

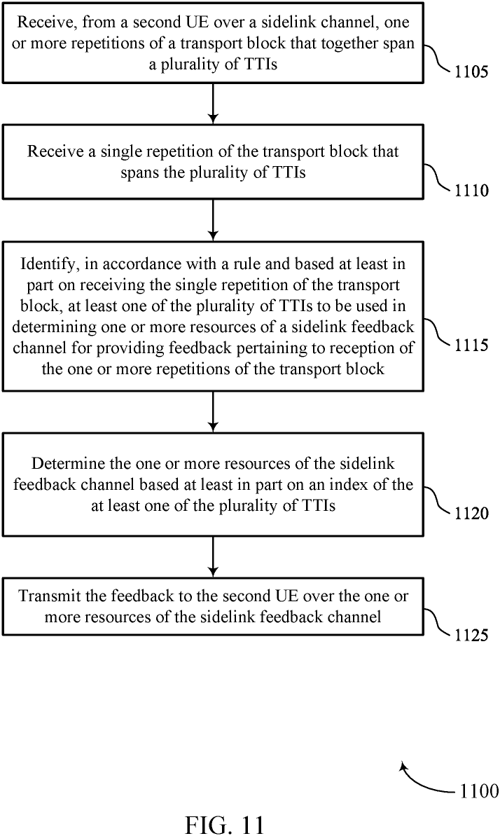

FIG. 11 shows a flowchart illustrating a method 1100 that supports techniques for sidelink feedback channel resource determination in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include receiving, from a second UE over a sidelink channel, one or more repetitions of a transport block that together span a plurality of TTIs. The operations of 1105 may be performed in accordance with examples as disclosed herein. In some examples, aspects of the operations of 1105 may be performed by a transport block component 825 as described with reference to FIG. 8.

At 1110, to receive the one or more repetitions of the transport block, the method may include receiving a single repetition of the transport block that spans the plurality of TTIs. The operations of 1110 may be performed in accordance with examples as disclosed herein. In some examples, aspects of the operations of 1110 may be performed by a transport block component 825 as described with reference to FIG. 8.

At 1115, the method may include identifying, in accordance with a rule and based at least in part on receiving the single repetition of the transport block, at least one of the plurality of TTIs to be used in determining one or more resources of a sidelink feedback channel for providing feedback pertaining to reception of the one or more repetitions of the transport block. The operations of 1115 may be performed in accordance with examples as disclosed herein. In some examples, aspects of the operations of 1115 may be performed by a TTI component 830 as described with reference to FIG. 8.

At 1120, the method may include determining the one or more resources of the sidelink feedback channel based at least in part on an index of the at least one of the plurality of TTIs. The operations of 1120 may be performed in accordance with examples as disclosed herein. In some examples, aspects of the operations of 1120 may be performed by a resource component 835 as described with reference to FIG. 8.

At 1125, the method may include transmitting the feedback to the second UE over the one or more resources of the sidelink feedback channel. The operations of 1125 may be performed in accordance with examples as disclosed herein. In some examples, aspects of the operations of 1125 may be performed by a communication component 840 as described with reference to FIG. 8.

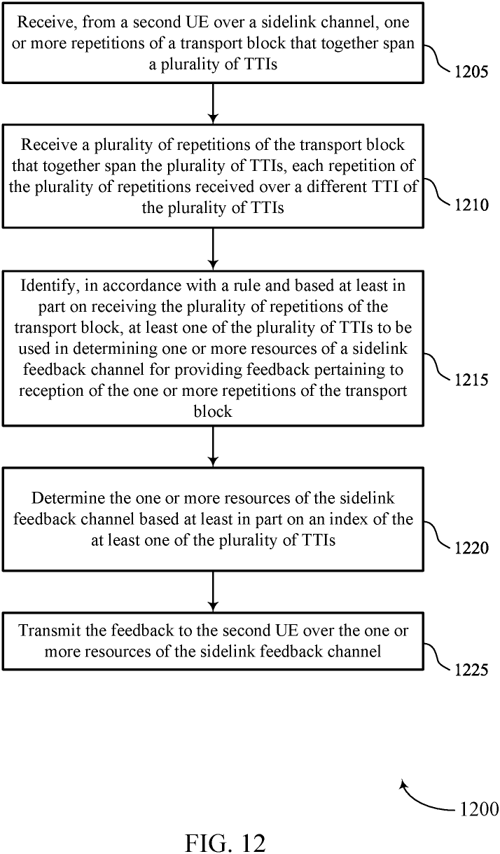

FIG. 12 shows a flowchart illustrating a method 1200 that supports techniques for sidelink feedback channel resource determination in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving, from a second UE over a sidelink channel, one or more repetitions of a transport block that together span a plurality of TTIs. The operations of 1205 may be performed in accordance with examples as disclosed herein. In some examples, aspects of the operations of 1205 may be performed by a transport block component 825 as described with reference to FIG. 8.

At 1210, to receive the one or more repetitions of the transport block, the method may include receiving a plurality of repetitions of the transport block that together span the plurality of TTIs, each repetition of the plurality of repetitions received over a different TTI of the plurality of TTIs. The operations of 1210 may be performed in accordance with examples as disclosed herein. In some examples, aspects of the operations of 1210 may be performed by a transport block component 825 as described with reference to FIG. 8.

At 1215, the method may include identifying, in accordance with a rule and based at least in part on receiving the plurality of repetitions of the transport block, at least one of the plurality of TTIs to be used in determining one or more resources of a sidelink feedback channel for providing feedback pertaining to reception of the one or more repetitions of the transport block. The operations of 1215 may be performed in accordance with examples as disclosed herein. In some examples, aspects of the operations of 1215 may be performed by a TTI component 830 as described with reference to FIG. 8.

At 1220, the method may include determining the one or more resources of the sidelink feedback channel based at least in part on an index of the at least one of the plurality of TTIs. The operations of 1220 may be performed in accordance with examples as disclosed herein. In some examples, aspects of the operations of 1220 may be performed by a resource component 835 as described with reference to FIG. 8.

At 1225, the method may include transmitting the feedback to the second UE over the one or more resources of the sidelink feedback channel. The operations of 1225 may be performed in accordance with examples as disclosed herein. In some examples, aspects of the operations of 1225 may be performed by a communication component 840 as described with reference to FIG. 8.

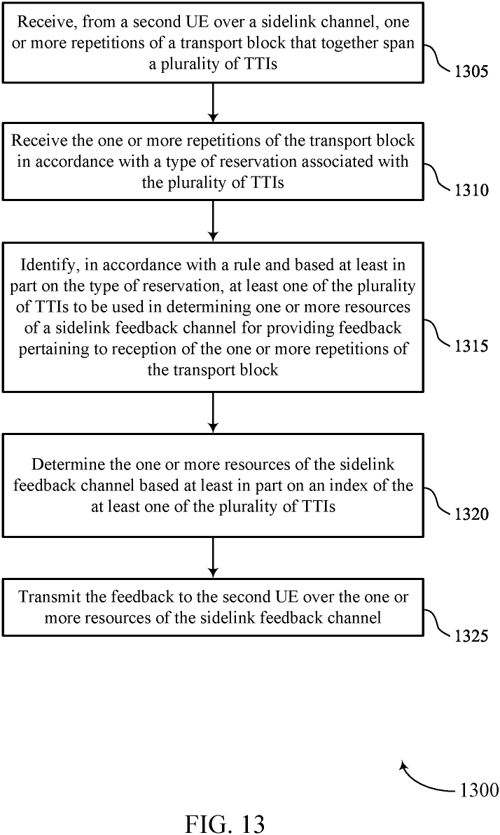

FIG. 13 shows a flowchart illustrating a method 1300 that supports techniques for sidelink feedback channel resource determination in accordance with aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1305, the method may include receiving, from a second UE over a sidelink channel, one or more repetitions of a transport block that together span a plurality of TTIs. The operations of 1305 may be performed in accordance with examples as disclosed herein. In some examples, aspects of the operations of 1305 may be performed by a transport block component 825 as described with reference to FIG. 8.

At 1310, to receive the one or more repetitions of the transport block, the method may include receiving the one or more repetitions of the transport block in accordance with a type of reservation associated with the plurality of TTIs. The operations of 1310 may be performed in accordance with examples as disclosed herein. In some examples, aspects of the operations of 1310 may be performed by a transport block component 825 as described with reference to FIG. 8.

At 1315, the method may include identifying, in accordance with a rule and based at least in part on the type of reservation, at least one of the plurality of TTIs to be used in determining one or more resources of a sidelink feedback channel for providing feedback pertaining to reception of the one or more repetitions of the transport block. The operations of 1315 may be performed in accordance with examples as disclosed herein. In some examples, aspects of the operations of 1315 may be performed by a TTI component 830 as described with reference to FIG. 8.

At 1320, the method may include determining the one or more resources of the sidelink feedback channel based at least in part on an index of the at least one of the plurality of TTIs. The operations of 1320 may be performed in accordance with examples as disclosed herein. In some examples, aspects of the operations of 1320 may be performed by a resource component 835 as described with reference to FIG. 8.

At 1325, the method may include transmitting the feedback to the second UE over the one or more resources of the sidelink feedback channel. The operations of 1325 may be performed in accordance with examples as disclosed herein. In some examples, aspects of the operations of 1325 may be performed by a communication component 840 as described with reference to FIG. 8.

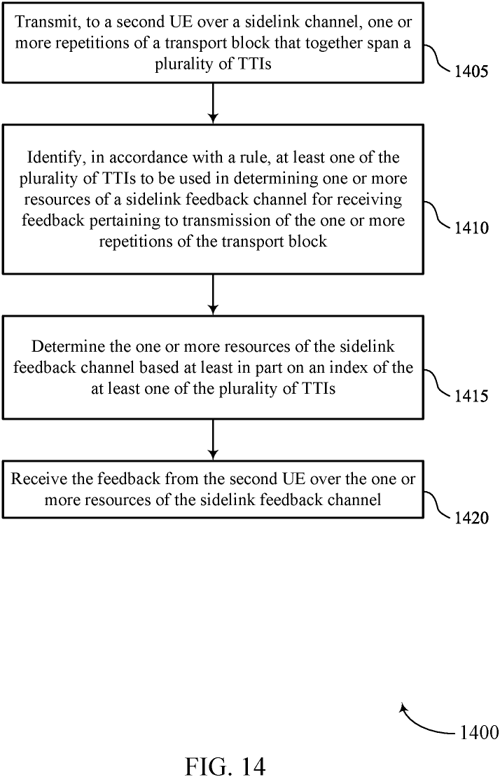

FIG. 14 shows a flowchart illustrating a method 1400 that supports techniques for sidelink feedback channel resource determination in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include transmitting, to a second UE over a sidelink channel, one or more repetitions of a transport block that together span a plurality of TTIs. The operations of 1405 may be performed in accordance with examples as disclosed herein. In some examples, aspects of the operations of 1405 may be performed by a transport block component 825 as described with reference to FIG. 8.

At 1410, the method may include identifying, in accordance with a rule, at least one of the plurality of TTIs to be used in determining one or more resources of a sidelink feedback channel for receiving feedback pertaining to transmission of the one or more repetitions of the transport block. The operations of 1410 may be performed in accordance with examples as disclosed herein. In some examples, aspects of the operations of 1410 may be performed by a TTI component 830 as described with reference to FIG. 8.

At 1415, the method may include determining the one or more resources of the sidelink feedback channel based at least in part on an index of the at least one of the plurality of TTIs. The operations of 1415 may be performed in accordance with examples as disclosed herein. In some examples, aspects of the operations of 1415 may be performed by a resource component 835 as described with reference to FIG. 8.

At 1420, the method may include receiving the feedback from the second UE over the one or more resources of the sidelink feedback channel. The operations of 1420 may be performed in accordance with examples as disclosed herein. In some examples, aspects of the operations of 1420 may be performed by a communication component 840 as described with reference to FIG. 8.

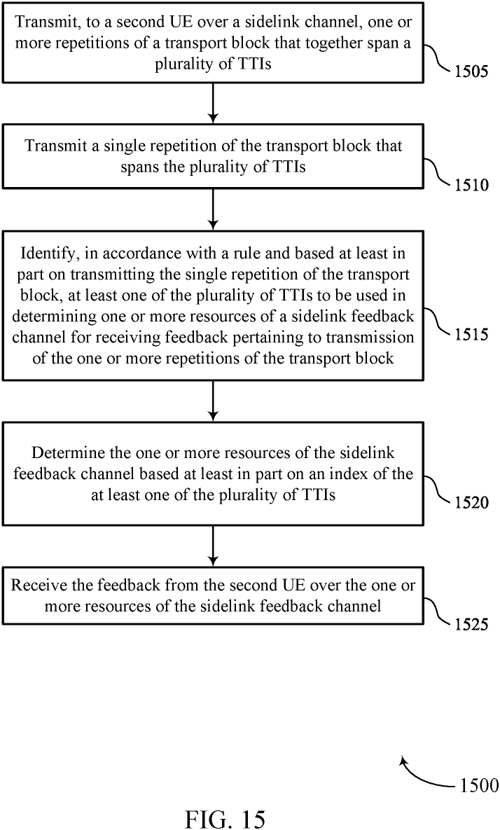

FIG. 15 shows a flowchart illustrating a method 1500 that supports techniques for sidelink feedback channel resource determination in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include transmitting, to a second UE over a sidelink channel, one or more repetitions of a transport block that together span a plurality of TTIs. The operations of 1505 may be performed in accordance with examples as disclosed herein. In some examples, aspects of the operations of 1505 may be performed by a transport block component 825 as described with reference to FIG. 8.

At 1510, to transmit the one or more repetitions of the transport block, the method may include transmitting a single repetition of the transport block that spans the plurality of TTIs. The operations of 1510 may be performed in accordance with examples as disclosed herein. In some examples, aspects of the operations of 1510 may be performed by a transport block component 825 as described with reference to FIG. 8.

At 1515, the method may include identifying, in accordance with a rule and based at least in part on transmitting the single repetition of the transport block, at least one of the plurality of TTIs to be used in determining one or more resources of a sidelink feedback channel for receiving feedback pertaining to transmission of the one or more repetitions of the transport block. The operations of 1515 may be performed in accordance with examples as disclosed herein. In some examples, aspects of the operations of 1515 may be performed by a TTI component 830 as described with reference to FIG. 8.

At 1520, the method may include determining the one or more resources of the sidelink feedback channel based at least in part on an index of the at least one of the plurality of TTIs. The operations of 1520 may be performed in accordance with examples as disclosed herein. In some examples, aspects of the operations of 1520 may be performed by a resource component 835 as described with reference to FIG. 8.

At 1525, the method may include receiving the feedback from the second UE over the one or more resources of the sidelink feedback channel. The operations of 1525 may be performed in accordance with examples as disclosed herein. In some examples, aspects of the operations of 1525 may be performed by a communication component 840 as described with reference to FIG. 8.

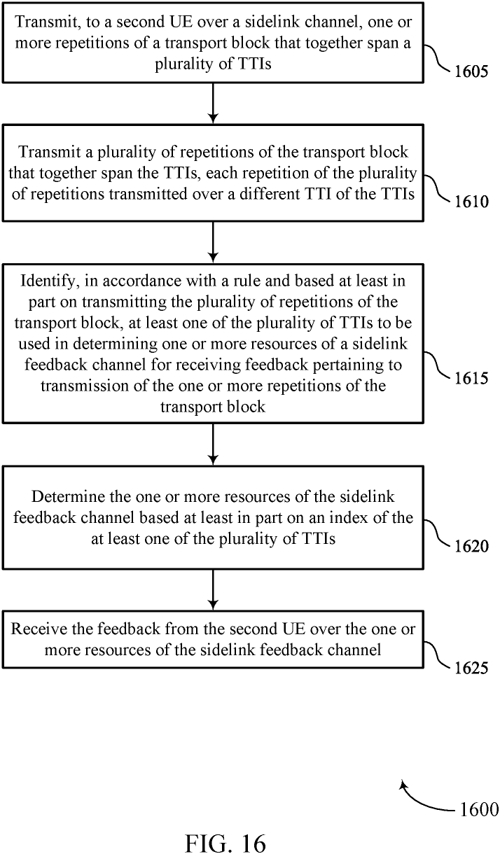

FIG. 16 shows a flowchart illustrating a method 1600 that supports techniques for sidelink feedback channel resource determination in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include transmitting, to a second UE over a sidelink channel, one or more repetitions of a transport block that together span a plurality of TTIs. The operations of 1605 may be performed in accordance with examples as disclosed herein. In some examples, aspects of the operations of 1605 may be performed by a transport block component 825 as described with reference to FIG. 8.

At 1610, to transmit the one or more repetitions of the transport block, the method may include transmitting a plurality of repetitions of the transport block that together span the TTIs, each repetition of the plurality of repetitions transmitted over a different TTI of the TTIs. The operations of 1610 may be performed in accordance with examples as disclosed herein. In some examples, aspects of the operations of 1610 may be performed by a transport block component 825 as described with reference to FIG. 8.

At 1615, the method may include identifying, in accordance with a rule and based at least in part on transmitting the plurality of repetitions of the transport block, at least one of the plurality of TTIs to be used in determining one or more resources of a sidelink feedback channel for receiving feedback pertaining to transmission of the one or more repetitions of the transport block. The operations of 1615 may be performed in accordance with examples as disclosed herein. In some examples, aspects of the operations of 1615 may be performed by a TTI component 830 as described with reference to FIG. 8.

At 1620, the method may include determining the one or more resources of the sidelink feedback channel based at least in part on an index of the at least one of the plurality of TTIs. The operations of 1620 may be performed in accordance with examples as disclosed herein. In some examples, aspects of the operations of 1620 may be performed by a resource component 835 as described with reference to FIG. 8.

At 1625, the method may include receiving the feedback from the second UE over the one or more resources of the sidelink feedback channel. The operations of 1625 may be performed in accordance with examples as disclosed herein. In some examples, aspects of the operations of 1625 may be performed by a communication component 840 as described with reference to FIG. 8.

The following provides an overview of aspects of the present disclosure:

Aspect 1: A method for wireless communication at a first UE, comprising: receiving, from a second UE over a sidelink channel, one or more repetitions of a transport block that together span a plurality of TTIs; identifying, in accordance with a rule, at least one of the plurality of TTIs to be used in determining one or more resources of a sidelink feedback channel for providing feedback pertaining to reception of the one or more repetitions of the transport block; determining the one or more resources of the sidelink feedback channel based at least in part on an index of the at least one of the plurality of TTIs; and transmitting the feedback to the second UE over the one or more resources of the sidelink feedback channel.

Aspect 2: The method of aspect 1, wherein receiving the one or more repetitions of the transport block comprises: receiving a single repetition of the transport block that spans the plurality of TTIs, wherein identifying the at least one of the plurality of TTIs is based at least in part on receiving the single repetition of the transport block.

Aspect 3: The method of aspect 2, wherein identifying the at least one of the plurality of TTIs further comprises: identifying, in accordance with the rule, that all of the plurality of TTIs are to be used in determining the one or more resources of the sidelink feedback channel, wherein the feedback comprises a quantity of feedback bits corresponding to a quantity of TTIs included in the plurality of TTIs, each feedback bit representing the feedback for the single repetition of the transport block.

Aspect 4: The method of any of aspects 2 through 3, wherein receiving the one or more repetitions of the transport block further comprises: receiving the one or more repetitions of the transport block during multiple feedback windows of time, each feedback window associated with a respective sidelink feedback channel occasion, wherein the sidelink feedback channel on which the feedback is transmitted is associated with a temporally last sidelink feedback channel occasion of the respective sidelink feedback channel occasions.

Aspect 5: The method of aspect 4, further comprising: generating the feedback after an entirety of the single repetition of the transport block is received.

Aspect 6: The method of aspect 1, wherein receiving the one or more repetitions of the transport block comprises: receiving a plurality of repetitions of the transport block that together span the plurality of TTIs, each repetition of the plurality of repetitions received over a different TTI of the plurality of TTIs, wherein identifying the at least one of the plurality of TTIs is based at least in part on receiving the plurality of repetitions of the transport block.

Aspect 7: The method of aspect 6, further comprising: generating acknowledgement information indicating whether the first UE successfully received the transport block based at least in part on decoding the plurality of repetitions of the transport block, wherein the feedback comprises the acknowledgement information.

Aspect 8: The method of aspect 7, wherein determining the one or more resources of the sidelink feedback channel comprises: determining, for each TTI of the plurality of TTIs, a resource of the sidelink feedback channel based at least in part on an index of the TTI and based at least in part on a starting subchannel index of the transport block within the TTI or a quantity of subchannels associated with a sidelink shared channel included in the TTI, wherein transmitting the feedback to the second UE comprises: transmitting the acknowledgement information over each resource of the sidelink feedback channel determined for each TTI.

Aspect 9: The method of any of aspects 6 through 8, further comprising: generating, for each repetition of the plurality of repetitions of the transport block, acknowledgement information indicating whether the first UE successfully received the repetition, wherein the feedback comprises respective acknowledgement information for each repetition, and wherein a respective resource of the sidelink feedback channel used to transmit the respective acknowledgement information is determined based at least in part on an index of a respective TTI and based at least in part on a starting subchannel index of the transport block within the respective TTI or a quantity of subchannels associated with a sidelink shared channel included in the respective TTI.

Aspect 10: The method of any of aspects 6 through 9, further comprising: determining that a first subset of repetitions of the plurality of repetitions is received before a minimum time gap before a first sidelink feedback channel occasion and that a second subset of repetitions of the plurality of repetitions is received after the minimum time gap; generating first acknowledgement information indicating whether the first UE successfully received the first subset of repetitions based at least in part on decoding the first subset of repetitions, wherein the feedback comprises the first acknowledgement information and the sidelink feedback channel corresponding to the first sidelink feedback channel occasion; generating second acknowledgement information indicating whether the first UE successfully received the transport block based at least in part on decoding the first subset of repetitions and the second subset of repetitions; and transmitting second feedback to the second UE comprising the second acknowledgement information over one or more resources of a second sidelink feedback channel corresponding to a second sidelink feedback channel occasion subsequent to the first sidelink feedback channel occasion.

Aspect 11: The method of any of aspects 1 through 10, wherein identifying the at least one of the plurality of TTIs comprises: identifying, in accordance with the rule, a temporally last TTI of the plurality of TTIs, wherein determining the one or more resources of the sidelink feedback channel is based at least in part on an index of the temporally last TTI and based at least in part on a starting subchannel index of the transport block within the temporally last TTI or a quantity of subchannels associated with a sidelink shared channel included in the temporally last TTI.

Aspect 12: The method of any of aspects 1 through 10, wherein identifying the at least one of the plurality of TTIs comprises: identifying, in accordance with the rule, a temporally first TTI of the plurality of TTIs, wherein determining the one or more resources of the sidelink feedback channel is based at least in part on an index of the temporally first TTI and based at least in part on a starting subchannel index of the transport block within the temporally first TTI or a quantity of subchannels associated with a sidelink shared channel included in the temporally first TTI.

Aspect 13: The method of any of aspects 1 through 12, wherein the plurality of TTIs comprises a plurality of mini-slots included in a slot, the index of the at least one of the plurality of TTIs corresponding to an index of the slot.

Aspect 14: The method of any of aspects 1 through 13, wherein receiving the one or more repetitions of the transport block comprises: receiving the one or more repetitions of the transport block in accordance with a type of reservation associated with the plurality of TTIs, wherein identifying the at least one of the plurality of TTIs is based at least in part on the type of reservation.

Aspect 15: The method of any of aspects 1 through 14, further comprising: determining the one or more resources of the sidelink feedback channel based at least in part on a respective starting subchannel index of the transport block within the at least one of the plurality of TTIs or a respective quantity of subchannels associated with a sidelink shared channel included in the at least one of the plurality of TTIs.

Aspect 16: The method of any of aspects 1 through 15, wherein the feedback comprises a plurality of feedback bits, each feedback bit transmitted using a different cyclic shift within non-overlapping resource blocks.

Aspect 17: The method of any of aspects 1 through 15, wherein the feedback comprises a plurality of feedback bits, each feedback bit transmitted using a same cyclic shift sequence per resource block.

Aspect 18: The method of any of aspects 1 through 17, wherein the plurality of TTIs comprises a plurality of slots or a plurality of mini-slots.

Aspect 19: A method for wireless communication at a first UE, comprising, comprising: transmitting, to a second UE over a sidelink channel, one or more repetitions of a transport block that together span a plurality of TTIs; identifying, in accordance with a rule, at least one of the plurality of TTIs to be used in determining one or more resources of a sidelink feedback channel for receiving feedback pertaining to transmission of the one or more repetitions of the transport block; determining the one or more resources of the sidelink feedback channel based at least in part on an index of the at least one of the plurality of TTIs; and receiving the feedback from the second UE over the one or more resources of the sidelink feedback channel.

Aspect 20: The method of aspect 19, wherein transmitting the one or more repetitions of the transport block comprises: transmitting a single repetition of the transport block that spans the plurality of TTIs, wherein identifying the at least one of the plurality of TTIs is based at least in part on transmitting the single repetition of the transport block.

Aspect 21: The method of aspect 19, wherein transmitting the one or more repetitions of the transport block comprises: transmitting a plurality of repetitions of the transport block that together span the plurality of TTIs, each repetition of the plurality of repetitions transmitted over a different TTI of the plurality of TTIs, wherein identifying the at least one of the plurality of TTIs is based at least in part on transmitting the plurality of repetitions of the transport block.

Aspect 22: The method of any of aspects 19 through 21, wherein transmitting the one or more repetitions of the transport block comprises: transmitting the one or more repetitions of the transport block in accordance with a type of reservation associated with the plurality of TTIs, wherein identifying the at least one of the plurality of TTIs is based at least in part on the type of reservation.

Aspect 23: The method of any of aspects 19 through 22, further comprising: determining the one or more resources of the sidelink feedback channel based at least in part on a respective starting subchannel index of the transport block within the at least one of the plurality of TTIs or a respective quantity of subchannels associated with a sidelink shared channel included in the at least one of the plurality of TTIs.

Aspect 24: An apparatus for wireless communication at a first UE, comprising at least one processor; and memory coupled with the processor, the memory storing instructions executable by the at least one processor to cause the apparatus to perform a method of any of aspects 1 through 18.

Aspect 25: An apparatus for wireless communication at a first UE, comprising at least one means for performing a method of any of aspects 1 through 18.

Aspect 26: A non-transitory computer-readable medium storing code for wireless communication at a first UE, the code comprising instructions executable by at least one processor to perform a method of any of aspects 1 through 18.

Aspect 27: An apparatus for wireless communication at a first UE, comprising at least one processor; and memory coupled with the at least one processor, the memory storing instructions executable by the at least one processor to cause the apparatus to perform a method of any of aspects 19 through 23.

Aspect 28: An apparatus for wireless communication at a first UE, comprising at least one means for performing a method of any of aspects 19 through 23.

Aspect 29: A non-transitory computer-readable medium storing code for wireless communication at a first UE, the code comprising instructions executable by at least one processor to perform a method of any of aspects 19 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving, from a second UE over a sidelink channel, one or more repetitions of a transport block that together span a plurality of transmission time intervals;
identifying, in accordance with a rule, at least one of the plurality of transmission time intervals to be used in determining one or more resources of a sidelink feedback channel for providing feedback pertaining to reception of the one or more repetitions of the transport block;
determining the one or more resources of the sidelink feedback channel based at least in part on an index of the at least one of the plurality of transmission time intervals; and
transmitting the feedback to the second UE over the one or more resources of the sidelink feedback channel.

2. The method of claim 1, wherein receiving the one or more repetitions of the transport block comprises:
receiving a single repetition of the transport block that spans the plurality of transmission time intervals, wherein identifying the at least one of the plurality of transmission time intervals is based at least in part on receiving the single repetition of the transport block.

3. The method of claim 2, wherein identifying the at least one of the plurality of transmission time intervals further comprises:
identifying, in accordance with the rule, that all of the plurality of transmission time intervals are to be used in determining the one or more resources of the sidelink feedback channel, wherein the feedback comprises a quantity of feedback bits corresponding to a quantity of transmission time intervals included in the plurality of transmission time intervals, each feedback bit representing the feedback for the single repetition of the transport block.

4. The method of claim 2, wherein receiving the one or more repetitions of the transport block further comprises:
receiving the one or more repetitions of the transport block during multiple feedback windows of time, each feedback window associated with a respective sidelink feedback channel occasion, wherein the sidelink feedback channel on which the feedback is transmitted is associated with a temporally last sidelink feedback channel occasion of the respective sidelink feedback channel occasions.

5. The method of claim 4, further comprising:
generating the feedback after an entirety of the single repetition of the transport block is received.

6. The method of claim 1, wherein receiving the one or more repetitions of the transport block comprises:
receiving a plurality of repetitions of the transport block that together span the plurality of transmission time intervals, each repetition of the plurality of repetitions received over a different transmission time interval of the plurality of transmission time intervals, wherein identifying the at least one of the plurality of transmission time intervals is based at least in part on receiving the plurality of repetitions of the transport block.

7. The method of claim 6, further comprising:
generating acknowledgement information indicating whether the first UE successfully received the transport block based at least in part on decoding the plurality of repetitions of the transport block, wherein the feedback comprises the acknowledgement information.

8. The method of claim 7, wherein determining the one or more resources of the sidelink feedback channel comprises:
determining, for each transmission time interval of the plurality of transmission time intervals, a resource of the sidelink feedback channel based at least in part on an index of the transmission time interval and based at least in part on a starting subchannel index of the transport block within the transmission time interval or a quantity of subchannels associated with a sidelink shared channel included in the transmission time interval, wherein transmitting the feedback to the second UE comprises:
transmitting the acknowledgement information over each resource of the sidelink feedback channel determined for each transmission time interval.

9. The method of claim 6, further comprising:
generating, for each repetition of the plurality of repetitions of the transport block, acknowledgement information indicating whether the first UE successfully received the repetition, wherein the feedback comprises respective acknowledgement information for each repetition, and
wherein a respective resource of the sidelink feedback channel used to transmit the respective acknowledgement information is determined based at least in part on an index of a respective transmission time interval and based at least in part on a starting subchannel index of the transport block within the respective transmission time interval or a quantity of subchannels associated with a sidelink shared channel included in the respective transmission time interval.

10. The method of claim 6, further comprising:
determining that a first subset of repetitions of the plurality of repetitions is received before a minimum time gap before a first sidelink feedback channel occasion and that a second subset of repetitions of the plurality of repetitions is received after the minimum time gap;
generating first acknowledgement information indicating whether the first UE successfully received the first subset of repetitions based at least in part on decoding the first subset of repetitions, wherein the feedback comprises the first acknowledgement information and the sidelink feedback channel corresponding to the first sidelink feedback channel occasion;
generating second acknowledgement information indicating whether the first UE successfully received the transport block based at least in part on decoding the first subset of repetitions and the second subset of repetitions; and
transmitting second feedback to the second UE comprising the second acknowledgement information over one or more resources of a second sidelink feedback channel corresponding to a second sidelink feedback channel occasion subsequent to the first sidelink feedback channel occasion.

11. The method of claim 1, wherein identifying the at least one of the plurality of transmission time intervals comprises:
identifying, in accordance with the rule, a temporally last transmission time interval of the plurality of transmission time intervals, wherein determining the one or more resources of the sidelink feedback channel is based at least in part on an index of the temporally last transmission time interval and based at least in part on a starting subchannel index of the transport block within the temporally last transmission time interval or a quantity of subchannels associated with a sidelink shared channel included in the temporally last transmission time interval.

12. The method of claim 1, wherein identifying the at least one of the plurality of transmission time intervals comprises:
identifying, in accordance with the rule, a temporally first transmission time interval of the plurality of transmission time intervals, wherein determining the one or more resources of the sidelink feedback channel is based at least in part on an index of the temporally first transmission time interval and based at least in part on a starting subchannel index of the transport block within the temporally first transmission time interval or a quantity of subchannels associated with a sidelink shared channel included in the temporally first transmission time interval.

13. The method of claim 1, wherein the plurality of transmission time intervals comprises a plurality of mini-slots included in a slot, the index of the at least one of the plurality of transmission time intervals corresponding to an index of the slot.

14. The method of claim 1, wherein receiving the one or more repetitions of the transport block comprises:
receiving the one or more repetitions of the transport block in accordance with a type of reservation associated with the plurality of transmission time intervals, wherein identifying the at least one of the plurality of transmission time intervals is based at least in part on the type of reservation.

15. The method of claim 1, further comprising:
determining the one or more resources of the sidelink feedback channel based at least in part on a respective starting subchannel index of the transport block within the at least one of the plurality of transmission time intervals or a respective quantity of subchannels associated with a sidelink shared channel included in the at least one of the plurality of transmission time intervals.

16. The method of claim 1, wherein the feedback comprises a plurality of feedback bits, each feedback bit transmitted using a different cyclic shift within nonoverlapping resource blocks.

17. The method of claim 1, wherein the feedback comprises a plurality of feedback bits, each feedback bit transmitted using a same cyclic shift sequence per resource block.

18. The method of claim 1, wherein the plurality of transmission time intervals comprises a plurality of slots or a plurality of mini-slots.

19. A method for wireless communication at a first user equipment (UE), comprising, comprising:
transmitting, to a second UE over a sidelink channel, one or more repetitions of a transport block that together span a plurality of transmission time intervals;
identifying, in accordance with a rule, at least one of the plurality of transmission time intervals to be used in determining one or more resources of a sidelink feedback channel for receiving feedback pertaining to transmission of the one or more repetitions of the transport block;
determining the one or more resources of the sidelink feedback channel based at least in part on an index of the at least one of the plurality of transmission time intervals; and
receiving the feedback from the second UE over the one or more resources of the sidelink feedback channel.

20. The method of claim 19, wherein transmitting the one or more repetitions of the transport block comprises:
transmitting a single repetition of the transport block that spans the plurality of transmission time intervals, wherein identifying the at least one of the plurality of transmission time intervals is based at least in part on transmitting the single repetition of the transport block.

21. The method of claim 19, wherein transmitting the one or more repetitions of the transport block comprises:
transmitting a plurality of repetitions of the transport block that together span the plurality of transmission time intervals, each repetition of the plurality of repetitions transmitted over a different transmission time interval of the plurality of transmission time intervals, wherein identifying the at least one of the plurality of transmission time intervals is based at least in part on transmitting the plurality of repetitions of the transport block.

22. The method of claim 19, wherein transmitting the one or more repetitions of the transport block comprises:
transmitting the one or more repetitions of the transport block in accordance with a type of reservation associated with the plurality of transmission time intervals, wherein identifying the at least one of the plurality of transmission time intervals is based at least in part on the type of reservation.

23. The method of claim 19, further comprising:
determining the one or more resources of the sidelink feedback channel based at least in part on a respective starting subchannel index of the transport block within the at least one of the plurality of transmission time intervals or a respective quantity of subchannels associated with a sidelink shared channel included in the at least one of the plurality of transmission time intervals.

24. An apparatus for wireless communication at a first user equipment (UE), comprising:
at least one processor; and
memory coupled with the at least one processor, the memory storing instructions executable by the at least one processor to cause the apparatus to:
receive, from a second UE over a sidelink channel, one or more repetitions of a transport block that together span a plurality of transmission time intervals;
identify, in accordance with a rule, at least one of the plurality of transmission time intervals to be used in determining one or more resources of a sidelink feedback channel for providing feedback pertaining to reception of the one or more repetitions of the transport block;
determine the one or more resources of the sidelink feedback channel based at least in part on an index of the at least one of the plurality of transmission time intervals; and
transmit the feedback to the second UE over the one or more resources of the sidelink feedback channel.

25. The apparatus of claim 24, wherein the instructions to receive the one or more repetitions of the transport block are executable by the at least one processor to cause the apparatus to:
receive a single repetition of the transport block that spans the plurality of transmission time intervals, wherein identifying the at least one of the plurality of transmission time intervals is based at least in part on receiving the single repetition of the transport block.

26. The apparatus of claim 24, wherein the instructions to receive the one or more repetitions of the transport block are executable by the at least one processor to cause the apparatus to:
receive a plurality of repetitions of the transport block that together span the plurality of transmission time intervals, each repetition of the plurality of repetitions received over a different transmission time interval of the plurality of transmission time intervals, wherein identifying the at least one of the plurality of transmission time intervals is based at least in part on receiving the plurality of repetitions of the transport block.

27. The apparatus of claim 24, wherein the instructions to receive the one or more repetitions of the transport block are executable by the at least one processor to cause the apparatus to:
receive the one or more repetitions of the transport block in accordance with a type of reservation associated with the plurality of transmission time intervals, wherein identifying the at least one of the plurality of transmission time intervals is based at least in part on the type of reservation.

28. An apparatus for wireless communication at a first user equipment (UE), comprising:
at least one processor; and
memory coupled with the at least one processor, the memory storing instructions executable by the at least one processor to cause the apparatus to:
transmit, to a second UE over a sidelink channel, one or more repetitions of a transport block that together span a plurality of transmission time intervals;
identify, in accordance with a rule, at least one of the plurality of transmission time intervals to be used in determining one or more resources of a sidelink feedback channel for receiving feedback pertaining to transmission of the one or more repetitions of the transport block;
determine the one or more resources of the sidelink feedback channel based at least in part on an index of the at least one of the plurality of transmission time intervals; and
receive the feedback from the second UE over the one or more resources of the sidelink feedback channel.

29. The apparatus of claim 28, wherein the instructions to transmit the one or more repetitions of the transport block are executable by the at least one processor to cause the apparatus to:
transmit a single repetition of the transport block that spans the plurality of transmission time intervals, wherein identifying the at least one of the plurality of transmission time intervals is based at least in part on transmitting the single repetition of the transport block.

30. The apparatus of claim 28, wherein the instructions to transmit the one or more repetitions of the transport block are executable by the at least one processor to cause the apparatus to:
transmit a plurality of repetitions of the transport block that together span the plurality of transmission time intervals, each repetition of the plurality of repetitions transmitted over a different transmission time interval of the plurality of transmission time intervals, wherein identifying the at least one of the plurality of transmission time intervals is based at least in part on transmitting the plurality of repetitions of the transport block.
